(19) United States
(12) Patent Application Publication
(10) Pub. No.: US 2015/0269782 A1
(43) Pub. Date: Sep. 24, 2015

(54) AUGMENTED REALITY DISPLAY SYSTEM, AUGMENTED REALITY INFORMATION GENERATING APPARATUS, AUGMENTED REALITY DISPLAY APPARATUS, AND SERVER

(71) Applicant: Konica Minolta, Inc., Tokyo (JP)

(72) Inventors: Atsushi TAMURA, Amagasaki-shi (JP); Takeshi MINAMI, Amagasaki-shi (JP); Kenichi TAKAHASHI, Osaka (JP); Kenji MATSUHARA, Kawanishi-shi (JP); Kaitaku OZAWA, Nishinomiya-shi (JP); Yosuke TANIGUCHI, Osaka (JP); Yoshiaki SHIBUTA, Itami-shi (JP)

(73) Assignee: Konica Minolta, Inc., Tokyo (JP)

(21) Appl. No.: 14/663,940

(22) Filed: Mar. 20, 2015

(30) Foreign Application Priority Data
Mar. 20, 2014 (JP) 2014-058662

(51) Int. Cl. G06T 19/00; H04N 1/00; G06T 7/00

(52) U.S. Cl. CPC G06T 19/006; G06T 7/004; H04N 1/00408; H04N 2201/0094

(57) ABSTRACT

An augmented reality information generating apparatus acquires a content stored in an external device, determines a display area defined by a relative position to an object in the content, acquires related information related to the object, and generates augmented reality information in which the content, area information indicating the display area, and the related information are associated with each other. An augmented reality display apparatus acquires a first content, acquires augmented reality information that includes a second content having an identical object with an object in the first content, determines a reality display area in which a relative position to the object in the first content has the same relation with a relative position between the object in the second content and the display area, and displays the related information included in the augmented reality information in the reality display area.

This application is based on Japanese Patent Application No. 2014-058662 filed with Japan Patent Office on Mar. 20, 2014, the entire content of which is hereby incorporated by reference.

### BACKGROUND OF THE INVENTION

1. Field of the Invention

The present invention relates to an augmented reality display system, an augmented reality information generating apparatus included in the augmented reality display system, a server, a non-transitory computer-readable recording medium encoded with an augmented reality information generating program executed in the augmented reality information generating apparatus, an augmented reality display apparatus included in the augmented reality display system, a non-transitory computer-readable recording medium encoded with an augmented reality display program executed in the augmented reality display apparatus, and a data structure of augmented reality information.

2. Description of the Related Art

Augmented reality technology has recently been developed. For example, Japanese Patent Laid-Open No. 9-33271 describes an imaging device which includes imaging means such as a camera or a camcorder, display means for displaying video or data captured by the imaging means, detection means for detecting global position and direction of the imaging means at times through satellite navigation, storage means for storing map data, and control means for reading out three-dimensional global position coordinates of a predetermined one of objects displayed on the display means and attribute data such as the name of the object, converting the three-dimensional position coordinates into two-dimensional position coordinates of the display means, and displaying the attribute data on the two-dimensional position coordinates of the display means.

However, in the conventional imaging device, the three-dimensional global position coordinates of a predetermined object has to be stored in relation with the object. Moreover, the attribute data is displayed on the same position as the object in the captured video to hide the object, thereby making it difficult to view the object.

### SUMMARY OF THE INVENTION

According to an aspect of the present invention, an augmented reality display system includes an augmented reality information generating apparatus and an augmented reality display apparatus. The augmented reality information generating apparatus includes a processor configured to: acquire a content stored in an external device from the external device; determine a display area defined by a relative position to an object in the content; acquire related information related to the object; and generate augmented reality information in which the content, area information indicating the display area, and the related information are associated with each other. The augmented reality display apparatus includes a processor configured to: acquire a first content; acquire augmented reality information that includes a second content having an identical object with an object in the acquired first content; determine a reality display area in which a relative position to the object in the first content has an identical relation with a relative position between the object in the second content and the display area; and display the related information included in the acquired augmented reality information, in the determined reality display area.

According to another aspect of the present invention, an augmented reality information generating apparatus includes a processor configured to: acquire a content stored in an external device from the external device; determine a display area defined by a relative position to an object in the acquired content; acquire related information related to the object; and generate augmented reality information in which the content, area information indicating the display area, and the related information are associated with each other.

According to a further aspect of the present invention, an augmented reality display apparatus includes a processor configured to: acquire a first content; acquire augmented reality information that includes a second content having an identical object with an object in the acquired first content, the augmented reality information including, in addition to the second content, area information indicating a display area defined by a relative position to an object in the second content, and related information related to the object; determine a reality display area in which a relative position to the object in the first content has an identical relation with a relative position between the object in the second content and the display area; and display the related information included in the augmented reality information in the determined reality display area.

According to yet another aspect of the present invention, a server includes: an augmented reality information storage to store augmented reality information including a first content, area information indicating a display area defined by a relative position to an object in the first content, and related information related to the object; and a processor configured to receive a second content from an augmented reality display apparatus, extract augmented reality information that includes a first content having an identical object with an object in the received second content, from among the stored augmented reality information, and transmit the extracted augmented reality information to the augmented reality display apparatus.

According to a still further aspect of the present invention, a non-transitory computer-readable recording medium is encoded with an augmented reality information generating program. The program causes a computer controlling an augmented reality generating apparatus to execute: a generator-side content acquisition step of acquiring a content stored in an external device from the external device; an area determination step of determining a display area defined by a relative position to an object in the acquired content; a related information acquisition step of acquiring related information related to the object; and an augmented reality information generation step of generating augmented reality information in which the content, area information indicating the display area, and the related information are associated with each other.

According to another aspect of the present invention, a non-transitory computer-readable recording medium is encoded with an augmented reality display program. The program causes a computer controlling an augmented reality display apparatus to execute: a display-side content acquisition step of acquiring a first content; an augmented reality information acquisition step of acquiring augmented reality information that includes a second content having an identical object with an object in the acquired first content, the augmented reality information including, in addition to the second content, area information indicating a display area defined by a relative position to an object in the second content, and related information related to the object; a reality display area determination step of determining a reality display area in which a relative position to the object in the first content has an identical relation with a relative position between the object in the second content and the display area; and a display control step of displaying the related information included in the augmented reality information in the determined reality display area.

The foregoing and other features, aspects, and advantages of the present invention will become more apparent from the following detailed description of the present invention when taken in conjunction with the accompanying drawings.

### BRIEF DESCRIPTION OF THE DRAWINGS

FIG. 1 is a diagram showing an example of an overview of an augmented reality display system in an embodiment of the present invention.

FIG. 2 is an external perspective view of an MFP in the present embodiment.

FIG. 3 is a block diagram showing an example of a hardware configuration of the MFP in the present embodiment.

FIG. 4 is a block diagram showing an example of an overall hardware configuration of a portable information device in the present embodiment.

FIG. 5 is a block diagram showing an example of a hardware configuration of an HMD in the present embodiment.

FIG. 6 is a block diagram showing an example of a hardware configuration of a server in the present embodiment.

FIG. 7 is a diagram showing an example of a format of augmented reality information in the first embodiment.

FIG. 8 is a block diagram showing an example of the overall functions of the CPU of the portable information device functioning as an augmented reality display apparatus in the first embodiment.

FIG. 9 is a diagram showing an example of a background image.

FIG. 10 is a diagram showing an example of a captured image.

FIG. 11 is a diagram showing an example of a combined image.

FIG. 12 is a diagram illustrating an example of a format of basic information.

FIG. 13 is a block diagram showing an example of the functions of the CPU of the portable information device functioning as a basic information registering apparatus in the first embodiment.

FIG. 14 is a block diagram showing an example of the functions of the CPU of the MFP functioning as an augmented reality information registering apparatus in the first embodiment.

FIG. 15 is a block diagram showing an example of the functions of the CPU of the server in the first embodiment.

FIG. 16 is a block diagram showing an example of detailed functions of an augmented reality information extraction portion in the first embodiment.

FIG. 17 is a flowchart showing an example of the procedure of a basic information registration process in the first embodiment.

FIG. 18 is a flowchart showing an example of the procedure of an augmented reality information registration process in the first embodiment.

FIG. 19 is a flowchart showing an example of the procedure of an augmented reality information management process in the first embodiment.

FIG. 20 is a flowchart showing an example of the procedure of an augmented reality display process in the first embodiment.

FIG. 21 is a block diagram showing an example of the overall functions of the CPU of the portable information device functioning as the augmented reality display apparatus in the second embodiment.

FIG. 22 is a block diagram showing an example of the functions of the CPU of the server in the second embodiment.

FIG. 23 is a flowchart showing an example of the procedure of an augmented reality information management process in the second embodiment.

FIG. 24 is a flowchart showing an example of the procedure of an augmented reality display process in the second embodiment.

FIG. 25 is a diagram showing an example of a format of augmented reality information in the third embodiment.

FIG. 26 is a block diagram showing an example of the overall functions of the CPU of the portable information device functioning as the augmented reality display apparatus in the third embodiment.

FIG. 27 is a block diagram showing an example of the functions of the CPU of the MFP functioning as the augmented reality information registering apparatus in the third embodiment.

FIG. 28 is a block diagram showing an example of the functions of the CPU of the server in the third embodiment.

FIG. 29 is a flowchart showing an example of the procedure of an augmented reality information registration process in the third embodiment.

FIG. 30 is a flowchart showing an example of the procedure of an augmented reality information management process in the third embodiment.

FIG. 31 is a flowchart showing an example of the procedure of an augmented reality information display process in the third embodiment.

### DESCRIPTION OF THE PREFERRED EMBODIMENTS

Embodiments of the present invention will be described below in conjunction with the figures. In the following description, the same parts are denoted with the same reference numerals. Their names and functions are also the same. A detailed description thereof is therefore not repeated.

### First Embodiment

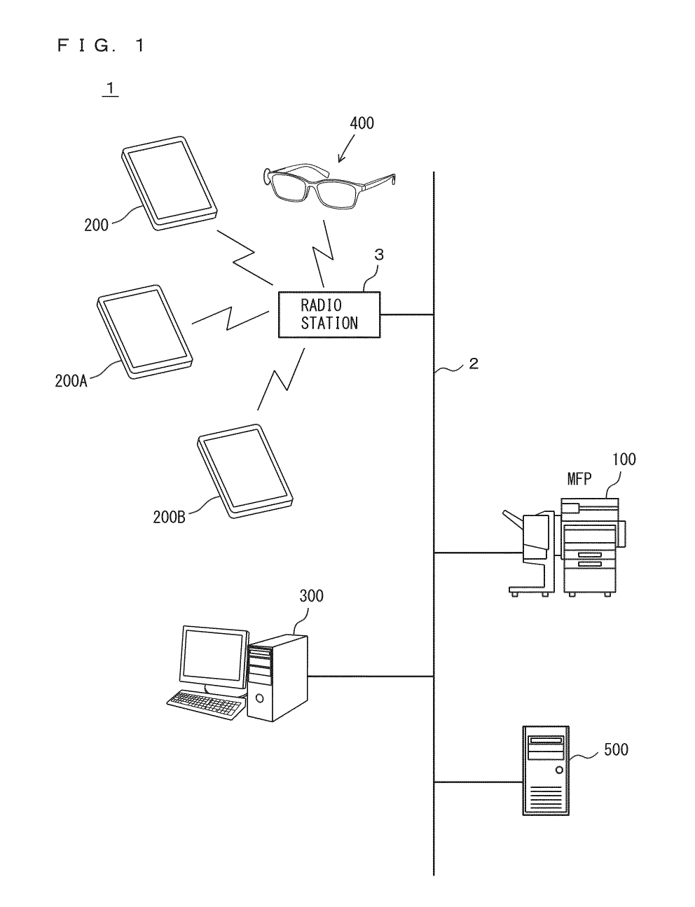

FIG. 1 is a diagram showing an example of an overview of an augmented reality display system in an embodiment of the present invention. Referring to FIG. 1, augmented reality display system 1 includes a radio station 3, an MFP (Multi Function Peripheral) 100, portable information devices 200, 200A, 200B, a personal computer (hereinafter referred to as “PC”) 300, a head mount display (hereinafter referred to as “HMD”) 400, and a server 500, each connected to network 2.

MFP 100 functions as an image processing apparatus and includes a document scanning function for scanning a document, an image forming function for forming an image on a recording medium such as paper based on image data, and a facsimile transmission/reception function for transmitting/receiving facsimile data. Although MFP 100 is described as an exemplary image processing apparatus in the first embodiment, MFP 100 may be replaced by an apparatus having a function of processing images, for example, such as PC 300 and server 500.

PC 300 is a general computer. A printer driver for controlling MFP 100 is installed in PC 300.

Portable information devices 200, 200A, 200B are exemplary information processing apparatuses. Portable information devices 200, 200A, 200B are, for example, PDAs (Personal Digital Assistants) or smart phones carried by users and have a data storing function and a wireless LAN function. An application program can be installed in portable information devices 200, 200A, 200B, as in PC 300. Portable information devices 200, 200A, 200B have the same hardware configuration and functions and, here, portable information device 200 is taken as an example, unless otherwise specified.

HMD 400 is shaped like eyeglasses and worn by a user when being used. HMD 400 has an imaging function of capturing an image of a subject, a display function of displaying an image on the glass portion of the eyeglasses, and a wireless LAN function. The user wearing HMD 400 can view a subject through the lenses and view an image displayed on the lenses at the same time.

Network 2 is a Local Area Network (LAN), either wired or wireless. Network 2 is not limited to a LAN and may be, for example, a network using a Public Switched Telephone network. Network 2 is connected to a Wide Area Network (WAN) such as the Internet.

MFP 100 can transmit/receive data to/from radio station 3, PC 300, and server 500 through network 2. Radio station 3 is a relay device for network 2 and communicates with portable information devices 200, 200A, 200B and HMD 400 having a wireless LAN communication function to connect portable information devices 200, 200A, 200B and HMD 400 to network 2. Portable information devices 200, 200A, 200B and HMD 400 each can transmit/receive data to/from MFP 100, PC 300, and server 500 through radio station 3 and network 2.

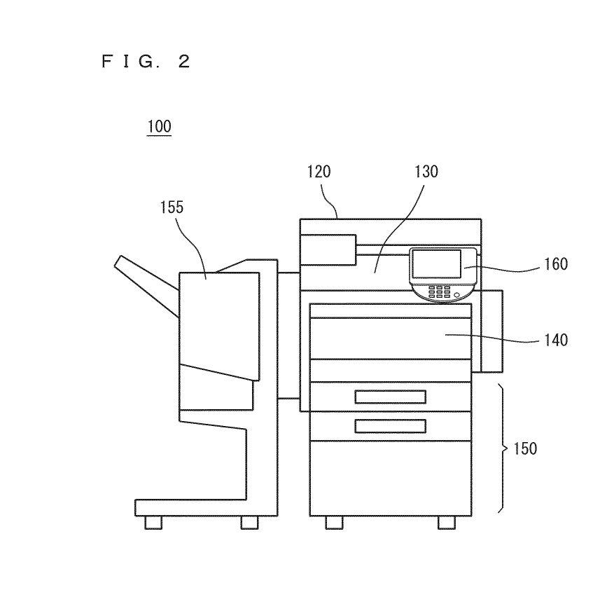

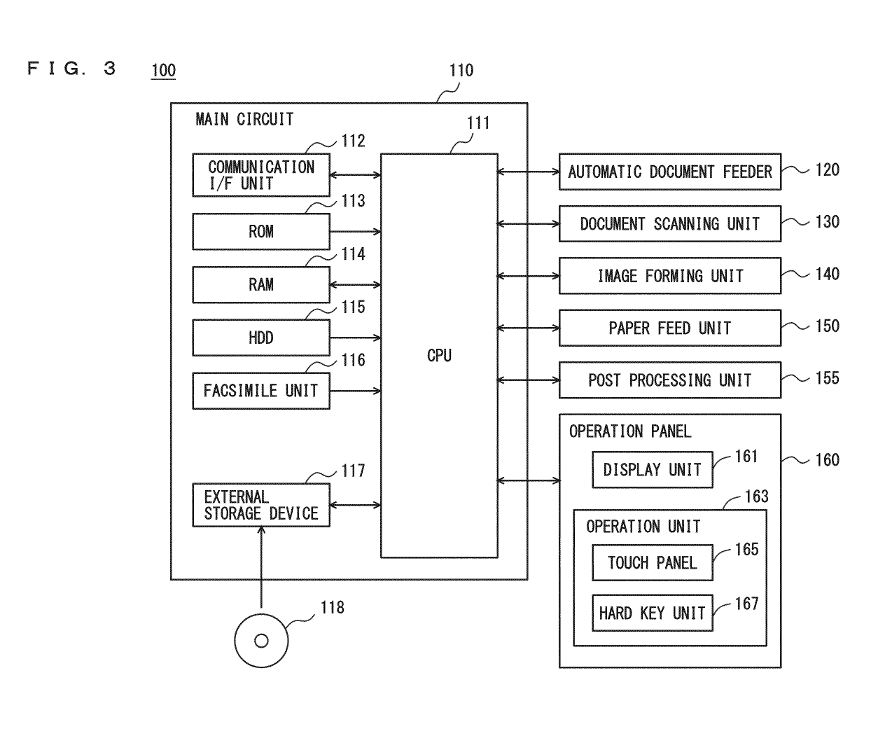

FIG. 2 is an external perspective view of the MFP in the present embodiment. FIG. 3 is a block diagram showing an example of a hardware configuration of the MFP in the present embodiment. Referring to FIG. 2 and FIG. 3, MFP 100 includes a main circuit 110, a document scanning unit 130 for scanning a document, an automatic document feeder 120 for conveying a document to document scanning unit 130, an image forming unit 140 for forming an image on paper or other medium based on image data output by document scanning unit 130 scanning a document, a paper feed unit 150 for supplying paper to image forming unit 140, a post processing unit 155 processing paper having an image formed thereon, and an operation panel 160 serving as a user interface.

Post-processing unit 155 executes a sorting process of sorting one or more sheets of paper having an image formed by image forming unit 140 and outputting the sorted sheets, a punching process of forming a punched hole, and a stapling process of stapling paper.

Main circuit 110 includes a CPU 111, a communication interface (I/F) unit 112, a ROM 113, a RAM 114, and a hard disk drive (HDD) 115 as a mass storage device, a facsimile unit 116, and an external storage device 117 to which a CD-ROM 118 is attached. CPU 111 is connected to automatic document feeder 120, document scanning unit 130, image forming unit 140, paper feed unit 150, and operation panel 160 to control the entire MFP 100.

ROM 113 stores a program executed by CPU 111 or data necessary for executing the program. RAM 114 is used as a work area when CPU 111 executes a program. RAM 114 temporarily stores scan data (image data) successively sent from document scanning unit 130.

Operation panel 160 is provided on the top of MFP 100 and includes a display unit 161 and an operation unit 163. Display unit 161 is a display device such as a liquid crystal display (LCD) or an organic ELD (Electro-Luminescence Display) and displays instruction menus to the user or information about the acquired image data. Operation unit 163 includes a hard-key unit 167 including a plurality of keys and accepts input of a variety of instructions and data such as characters and numerals through user's operations corresponding to the keys. Operation unit 163 further includes a touch panel 165 provided on display unit 161.

Communication I/F unit 112 is an interface for connecting MFP 100 to network 2. CPU 111 communicates with portable information devices 200, 200A, 200B, PC 300, HMD 400, and server 500 through communication I/F unit 112 to transmit/receive data. Communication I/F unit 112 can communicate with a computer connected to the Internet through network 2.

Facsimile unit 116 is connected to a Public Switched Telephone Network (PSTN) to transmit facsimile data to the PSTN or receive facsimile data from the PSTN. Facsimile unit 116 stores the received facsimile data into HDD 115 or outputs it to image forming unit 140. Image forming unit 140 prints the facsimile data received from facsimile unit 116 on paper.

Facsimile unit 116 also converts data stored in HDD 115 into facsimile data and transmits the converted facsimile data to a facsimile machine connected to the PSTN.

CD-ROM (Compact Disk ROM) 118 is attached to external storage device 117. CPU 111 can access CD-ROM 118 through external storage device 117. CPU 111 loads the program recorded on CD-ROM 118 attached to external storage device 117 into RAM 114 for execution. The program executed by CPU 111 can be stored not only in CD-ROM 118 but also in other media such as an optical disk (MO (Magnetic Optical Disc)/MD (Mini Disc)/DVD (Digital Versatile Disc)), an IC card, an optical card, and a semiconductor memory such as a mask ROM, an EPROM (Erasable Programmable ROM), and an EEPROM (Electrically EPROM).

The program executed by CPU 111 is not limited to a program recorded on CD-ROM 118. A program stored in HDD 115 may be loaded into RAM 114 for execution. In this case, another computer connected to network 2 may overwrite the program stored in HDD 115 of MFP 100 or additionally write a new program. MFP 100 may download a program from another computer connected to network 2 and store the program into HDD 115. The program referred to here includes not only a program directly executable by CPU 111 but also a source program, a compressed program, and an encrypted program.

In augmented reality display system 1, data is transmitted/received between MFP 100, portable information devices 200, 200A, 200B, PC 300, HDM 400, and server 500. Any protocol can be used to transmit/receive data as long as a transmission source can be specified at the receiver device. Examples of the protocol for transmitting/receiving data include HTTP (Hyper Text Transfer Protocol), FTP (File Transfer Protocol), SMPT (Simple Mail Transfer Protocol), and POP (Post Office Protocol).

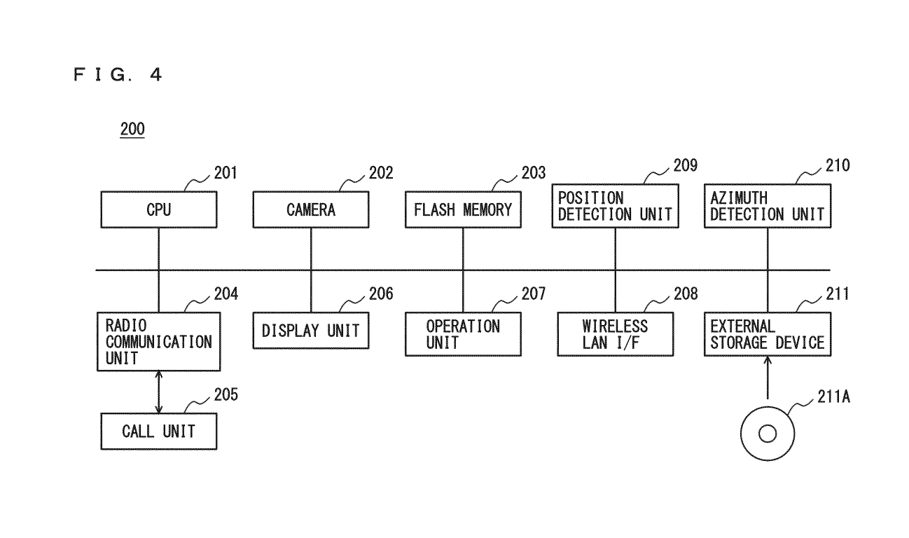

FIG. 4 is a block diagram showing an example of an overall hardware configuration of the portable information device in the present embodiment. Referring to FIG. 4, portable information device 200 includes a CPU 201 for controlling the entire portable information device 200, a camera 202, a flash memory 203 storing data in a nonvolatile manner, a radio communication unit 204 connected to a call unit 205, a display unit 206 displaying information, an operation unit 207 accepting a user's operation, a wireless LAN I/F 208, a position detection unit 209, an azimuth detection unit 210, and an external storage device 211.

Radio communication unit 204 communicates by radio with a mobile phone base station connected to a telephone communication network. Radio communication unit 204 connects portable information device 200 to the telephone communication network to enable a call using call unit 205. Radio communication unit 204 decodes a voice signal obtained by demodulating a radio signal received from a mobile phone base station and outputs the decoded signal to call unit 205. Radio communication unit 204 encodes voice input from call unit 205 and transmits the encoded signal to a mobile phone base station. Call unit 205 includes a microphone and a speaker. Voice input from radio communication unit 204 is output from the speaker, and voice input from the microphone is output to radio communication unit 204. Radio communication unit 204 is controlled by CPU 201 and connects portable information device 200 to an email server to transmit/receive emails.

Camera 202 includes a lens and an optoelectronic transducer and forms an image of light collected by the lens on the optoelectronic transducer. The optoelectronic transducer transduces the received light and outputs image data to CPU 201. The optoelectronic transducer is, for example, a CMOS (Complementary Metal Oxide Semiconductor) sensor or a CCD (Charge Coupled Device) sensor.

Display unit 206 is a display device such as an LCD or an organic ELD and displays, for example, instruction menus to the user and information about the acquired image data. Operation unit 207 includes a plurality of keys and accepts input of a variety of instructions and data such as characters and numerals through user's operations corresponding to the keys.

Wireless LAN I/F 208 is an interface that communicates with radio station 3 to connect portable information device 200 to network 2. The respective IP (Internet Protocol) addresses of HMD 400, server 500, MFP 100, and PC 300 are registered in portable information device 200, so that portable information device 200 can communicate with HMD 400, server 500, MFP 100, and PC 300 to transmit/receive data. Although portable information device 200 uses wireless LAN I/F 208 to communicate with MFP 100, PC 300, HMD 400, and server 500 in the present embodiment, other communication methods may be used. Specifically, if portable information device 200, MFP 100, PC 300, HMD 400, and server 500 each are equipped with a short-range wireless device such as Bluetooth (registered trademark), portable information device 200 may perform one-to one communication with any one of MFP 100, PC 300, HMD 400, and server 500. Portable information device 200 may be connected with any one of MFP 100, PC 300, HMD 400, and server 500 by wire, for example, through a USB (Universal Serial Bus) cable, so that portable information device 200 can perform one-to-one communication with any one of MFP 100, PC 300, HMD 400, and server 500.

Flash memory 203 stores a program executed by CPU 201 or data necessary to execute the program. CPU 201 loads the program recorded on flash memory 203 into the RAM of CPU 201 for execution.

Position detection unit 209 detects the present position of portable information device 200. Specifically, position detection unit 209 is a GPS (Global Positioning System) receiver and measures the present position by receiving radio waves from a plurality of GPS satellites. Position detection unit 209 outputs the value indicating the measured present position, for example, the latitude and the longitude to CPU 201.

Azimuth detection unit 210 detects the azimuth of the direction in which portable information device 200 is oriented. Specifically, azimuth detection unit 210 is a geomagnetic sensor measuring geomagnetism. Azimuth detection unit 210 outputs the detected azimuth to CPU 201. Azimuth detection unit 210 is installed in portable information device 200 so as to be able to detect the imaging direction of camera 202, in other words, the direction of the optical axis of the lens of camera 202. Azimuth detection unit 210 is not limited to a geomagnetic sensor but may be a gyro sensor or other sensors.

External storage device 211 is removably attached to portable information device 200, and CD-ROM 211A storing an augmented reality display program can be attached thereto. CPU 201 can access CD-ROM 211A through external storage device 211. CPU 201 loads the augmented reality display program recorded on CD-ROM 211A attached to external storage device 211 into the RAM of CPU 201 for execution.

Although the program executed by CPU 201 is recorded on flash memory 203 or CD-ROM 211A in the foregoing description, another computer connected to network 2 may overwrite the program stored in flash memory 203 or additionally write a new program. Portable information device 200 may execute a program downloaded from another computer connected to network 2. The program referred to here includes not only a program directly executable by CPU 201 but also a source program, a compressed program, and an encrypted program.

The medium storing the program executed by CPU 201 is not limited to CD-ROM 211A but may be an optical disk (MO/MD/DVD), an IC card, an optical card, or a semiconductor memory such as a ROM, an EPROM, and an EEPROM.

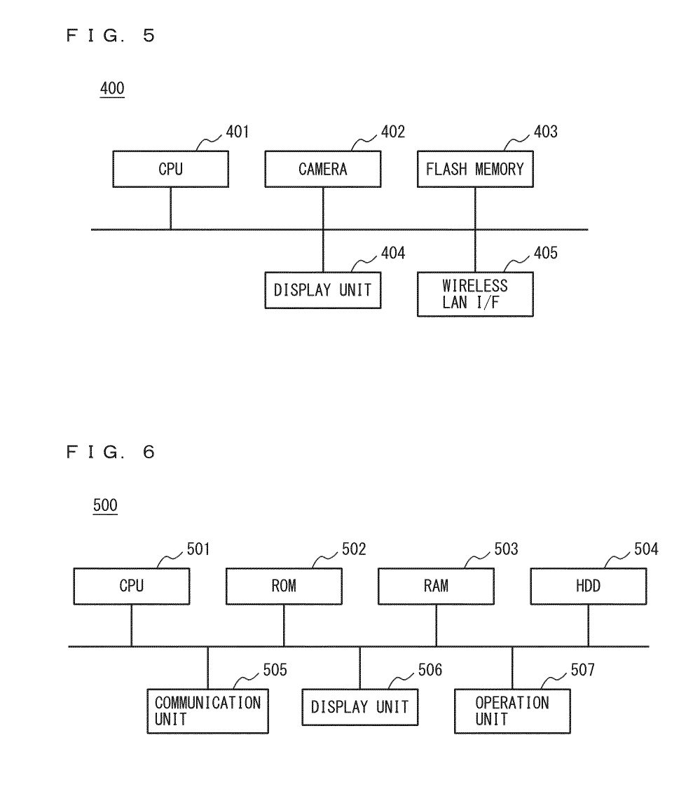

FIG. 5 is a block diagram showing an example of a hardware configuration of the HMD in the present embodiment. Referring to FIG. 5, HMD 400 in the present embodiment includes a CPU 401 for controlling the entire HMD 400, a camera 402, a flash memory 403 storing data in a nonvolatile manner, a display unit 404 displaying information, and a wireless LAN I/F 405.

Camera 402 includes a lens and an optoelectronic transducer and forms an image of light collected by the lens on the optoelectronic transducer. The optoelectronic transducer transduces the received light and outputs image data to CPU 401. The optoelectronic transducer is, for example, a CMOS (Complementary Metal Oxide Semiconductor) sensor or a CCD (Charge Coupled Device) sensor. Although camera 402 captures a still image here by way of example, a video camera for capturing moving images may be used. When a video camera is used, one of a plurality of frames included in moving images may be treated as a still image.

Display unit 404 is a liquid crystal display (LCD) formed of a transparent member and is fitted in the lens portion of HMD 400. The display surface of display unit 404 is arranged at the position determined with respect to the optical axis of camera 402. Specifically, the imaging range of camera 402 is set in the same field of view as when the user wears HMD 400. The image obtained by camera 402 capturing an image is the same image as in the field of view actually observed by the user. A position in the field of view of the user thus can be specified from the image output by camera 402. The display surface of display unit 404 is set in the same field of view in the lens portion as when user wears HMD 400. Accordingly, an image can be displayed in any position in the field of view of the user.

Wireless LAN I/F 405 is an interface that communicates with radio station 3 to connect HMD 400 to network 2. The IP (Internet Protocol) address of server 500 is registered in flash memory 403 so that HMD 400 can communicate with server 500 to transmit/receive data. Although HMD 400 uses wireless LAN I/F 405 to communicate with server 500 in the present embodiment, by way of example, other communication methods may be used. Specifically, if HMD 400 and server 500 each are equipped with, for example, a short-range wireless device such as Bluetooth (registered trademark), HMD 400 may perform one-to-one communication with server 500.

Flash memory 403 stores a program executed by CPU 401 or data necessary to execute the program. CPU 401 loads the program recorded on flash memory 403 into the RAM of CPU 401 for execution.

FIG. 6 is a block diagram showing an example of a hardware configuration of the server in the present embodiment. Referring to FIG. 6, server 500 includes a CPU 501 for controlling the entire server 500, a ROM 502 for storing the program executed by CPU 501, a RAM 503 used as a work area for CPU 501, an HDD 504 storing data in a nonvolatile manner, a communication unit 505 connecting CPU 501 to network 2, a display unit 506 displaying information, and an operation unit 507 accepting input of user's operation.

In augmented reality display system 1 in the present embodiment, augmented reality information is stored in server 500, and portable information device 200 functioning as an augmented reality display apparatus displays the augmented reality information downloaded from server 500.

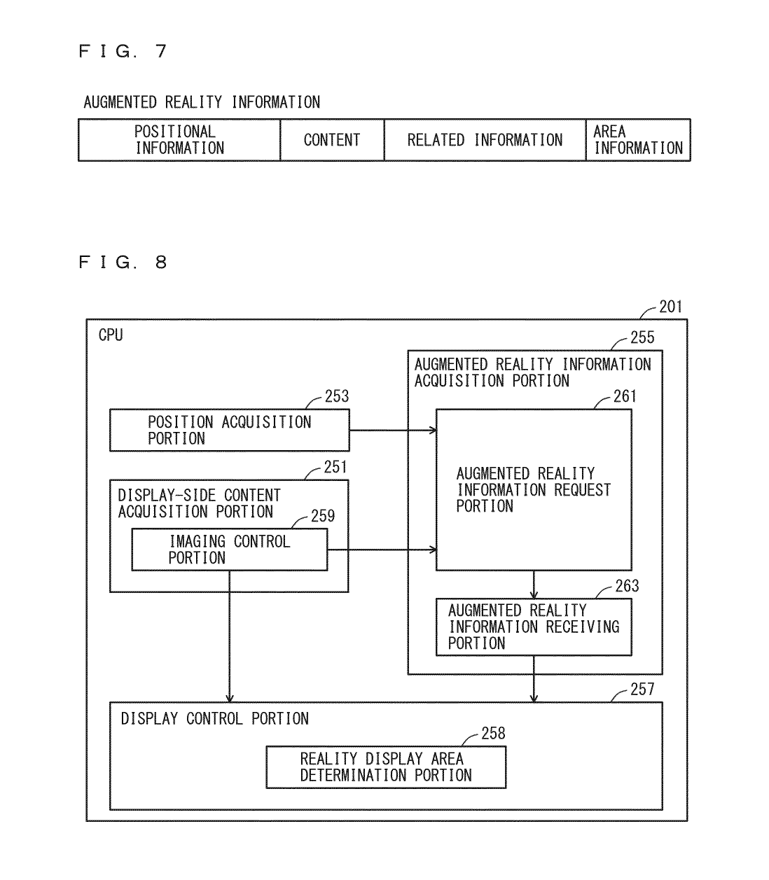

FIG. 7 is a diagram showing an example of a format of augmented reality information in the first embodiment. Referring to FIG. 7, augmented reality information includes a positional information item, a content item, a related information item, and an area information item. Positional information indicating a geographical position is set in the positional information item. A content is set in the content item. The content set here is a background image that is an image obtained by capturing an image of a subject at the position specified by the positional information set in the positional information item. Related information related to an object in the content is set in the related information item. Here, the information related to a subject in the background image set in the content item is set. Area information indicating the display area defined by the relative position to the object in the content is set in the area information item. The area information set here indicates the position of the area defined by the relative position to a subject in the background image set in the content item.

A specific example of a method of storing augmented reality information into server 500 will be described later. Augmented reality information is stored in server 500 in advance. Here, augmented reality information is registered in server 500, in which when an image of a whiteboard is captured in meeting room A, positional information indicating the position of meeting room A during image capturing is set in the positional information item, the captured image including the whiteboard as a subject is set in the content item, an image of a meeting material is set in the related information item, and an area including the entire drawing surface of the whiteboard included in the captured image as a subject is set in the area information item, by way of example.

FIG. 8 is a block diagram showing an example of the overall functions of the CPU of portable information device 200 functioning as the augmented reality display apparatus in the first embodiment. The functions shown in FIG. 8 are formed in CPU 201 by CPU 201 of portable information device 200, functioning as the augmented reality display apparatus, executing an augmented reality display program stored in flash memory 203. Referring to FIG. 8, CPU 201 includes a display-side content acquisition portion 251, a position acquisition portion 253 acquiring the geographical position of portable information device 200 at present, an augmented reality information acquisition portion 255 acquiring augmented reality information from server 500, and a display control portion 257 controlling display unit 161.

Display-side content acquisition portion 251 includes an imaging control portion 259 controlling camera 202. Imaging control portion 259 controls camera 202, acquires a captured image output by camera 202 capturing an image of a subject, and outputs the acquired captured image to display control portion 257 and augmented reality information acquisition portion 255. Display control portion 257 controls display unit 206 in response to input of a captured image from imaging control portion 259 and allows display unit 206 to display the captured image.

Position acquisition portion 253 controls position detection unit 209, allows position detection unit 209 to measure the present position, and acquires positional information indicating the present position output by position detection unit 209. Position acquisition portion 253 outputs the acquired positional information to augmented reality information acquisition portion 255.

Augmented reality information acquisition portion 255 acquires augmented reality information from server 500. Augmented reality information acquisition portion 255 includes an augmented reality information request portion 261 and an augmented reality information receiving portion 263. Augmented reality information acquisition portion 255 receives positional information from position acquisition portion 253 and receives a captured image from imaging control portion 259. Augmented reality information acquisition portion 255 transmits an augmented reality information transmission request including positional information and a captured image to server 500 through wireless LAN I/F 208. The IP address of server 500 may be stored in advance in flash memory 203 of portable information device 200. Server 500 receiving the augmented reality information transmission request, which will be detailed later, extracts the augmented reality information that includes positional information indicating the position in a predetermined range from the position specified by the positional information included in the augmented reality information transmission request and includes a background image having the same subject as in the captured image, and returns the extracted augmented reality information.

When wireless LAN I/F 208 receives augmented reality information from server 500, augmented reality information receiving portion 263 outputs the augmented reality information to display control portion 257.

In response to input of a captured image from imaging control portion 259, display control portion 257 displays the captured image on display unit 206. When augmented reality information is input from augmented reality information acquisition portion 255, display control portion 257 displays the related information set in the related information item in the augmented reality information on display unit 206.

Display control portion 257 includes a reality display area determination portion 258. Reality display area determination portion 258 specifies the relative position to the subject in the background image set in the content item in the augmented reality information, based on the area information set in the area information item in the augmented reality information, and determines the area present at the specified relative position as a reality display area, with respect to the subject in the captured image.

Display control portion 257 displays the related information set in the related information item in the augmented reality information, in the reality display area determined in the captured image. Specifically, display control portion 257 generates a combined image in which an image of the related information is combined in the reality display area in the captured image, and displays the generated combined image on display unit 206.

Reality display area determination portion 258 may specify the area specified by the area information set in the area information item, in the background image set in the content item included in the augmented reality information, and may determine the area in the captured image similar to the area specified in the background image, as an area for displaying the related information.

In the example described here, when a user captures an image of a whiteboard as a subject with camera 202 of portable information device 200 in a meeting room A, augmented reality information is received from server 500, in which the positional information indicating the position of meeting room A is set in the positional information item, the background image obtained by capturing an image of the whiteboard as a subject is set in the content item, an image of a meeting material is set in the related information, and an area including the entire drawing surface of the whiteboard in the background is set in the area information item. In this case, a combined image is displayed on display unit 206, in which the image of the meeting material as the related information is combined with the drawing surface of the whiteboard in the captured image. In actuality, even when characters or other information is not written on the drawing surface of the whiteboard, or even when no image is projected, a combined image in which the image of the meeting material is combined in the area of the drawing surface of the whiteboard in the captured image is displayed on display unit 206 of portable information device 200.

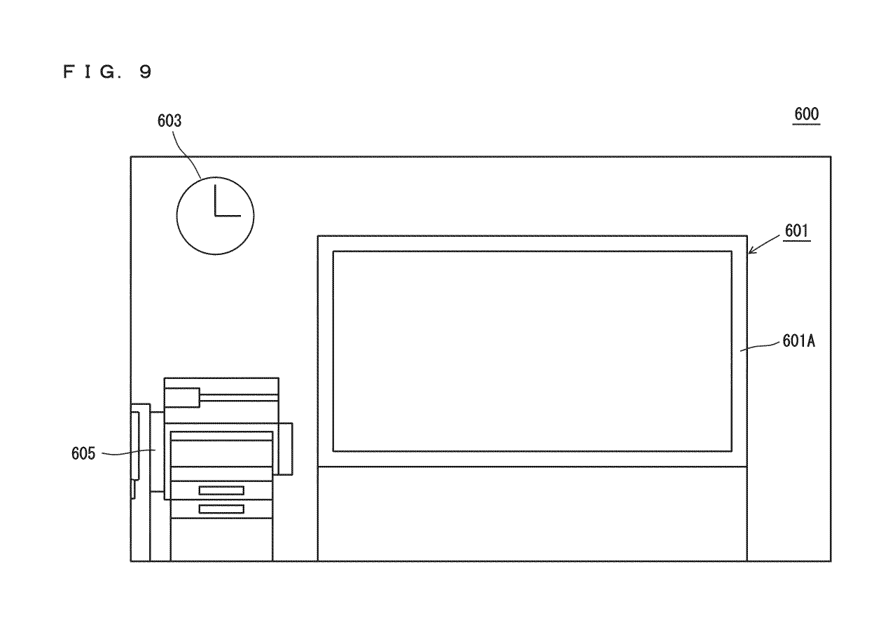

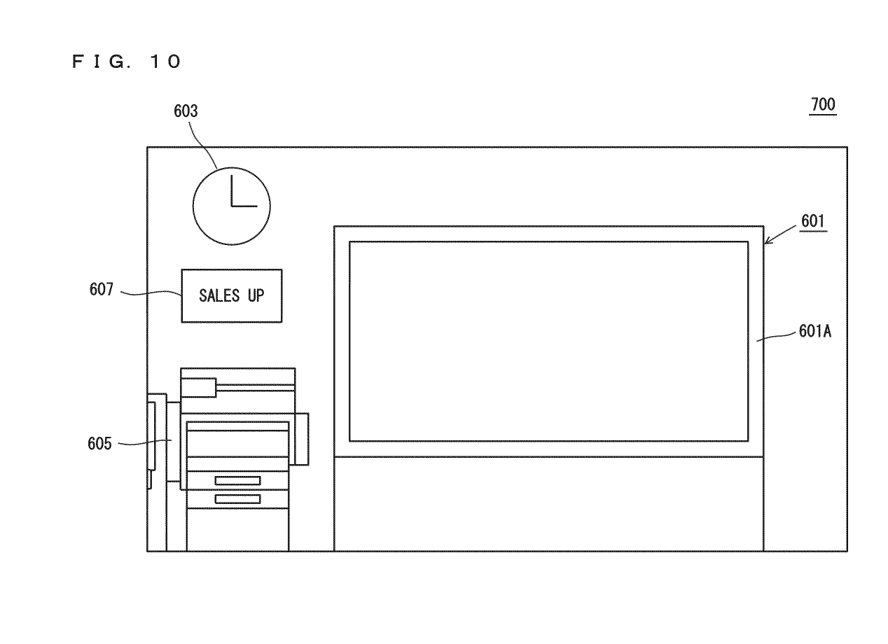

FIG. 9 is a diagram showing an example of the background image. The background image shown in FIG. 9 illustrates the background image that is set in the content item in the augmented reality information registered in server 500 and is obtained by capturing an image of the whiteboard as a subject in meeting room A. Referring to FIG. 9, a background image 600 includes a whiteboard 601, a clock 603, and an MFP 605 as subjects. Whiteboard 601 includes a drawing surface 601.

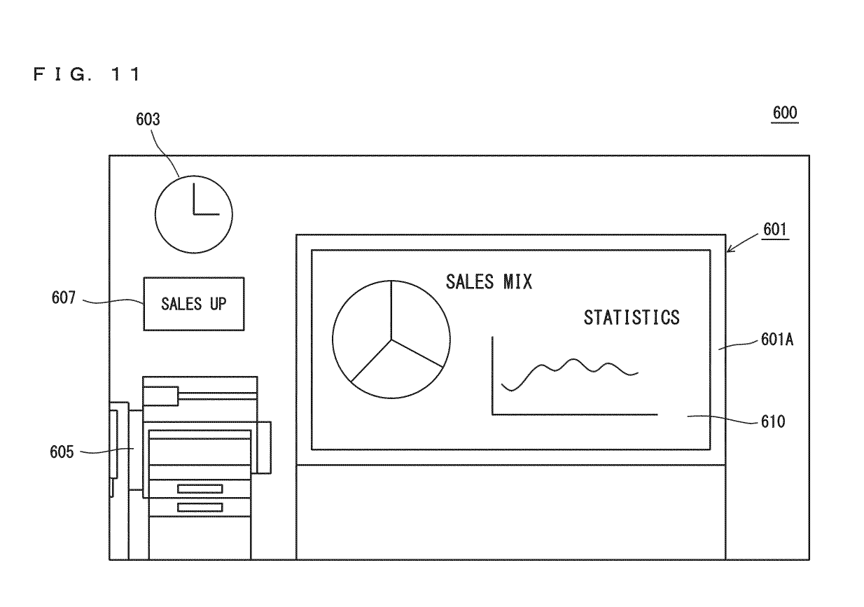

FIG. 10 is a diagram showing an example of the captured image. The captured image shown in FIG. 10 is an image obtained by capturing an image including whiteboard 601 as a subject, with portable information device 200 in meeting room A. Referring to FIG. 10, captured image 700 includes whiteboard 601, clock 603, MFP 605, and a poster 607 as subjects. Whiteboard 601 includes drawing surface 601. The captured image shown in FIG. 10 is an image obtained by capturing an image in meeting room A, and the capturing position is meeting room A. Captured image 700 includes whiteboard 601 as a subject.

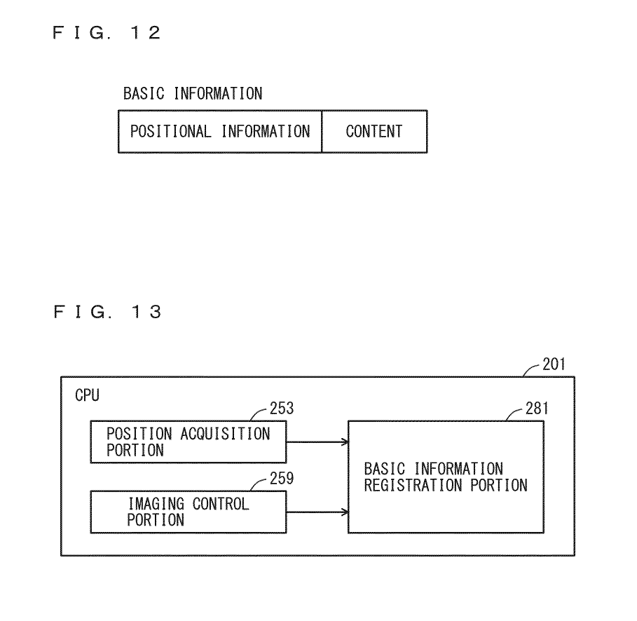

FIG. 11 is a diagram showing an example of the combined image. The combined image shown in FIG. 11 illustrates a combined image generated and displayed on display unit 206 when the captured image shown in FIG. 10 is acquired in portable information device 200 and augmented reality information including the background image shown in FIG. 9 is acquired from server 500. Referring to FIG. 11, related information 610 is included in the area of drawing surface 601A of whiteboard 601 in the captured image shown in FIG. 10.

An example of a method of registering augmented reality information in server 500 will now be described. Here, after a basic information registering apparatus registers basic information in the server, the augmented reality information generating apparatus generates augmented reality information based on the basic information registered in server 500 and registers the generated augmented reality information in server 500, by way of example. The basic information registering apparatus is portable information device 200, and the augmented reality information generating apparatus is MFP 100.

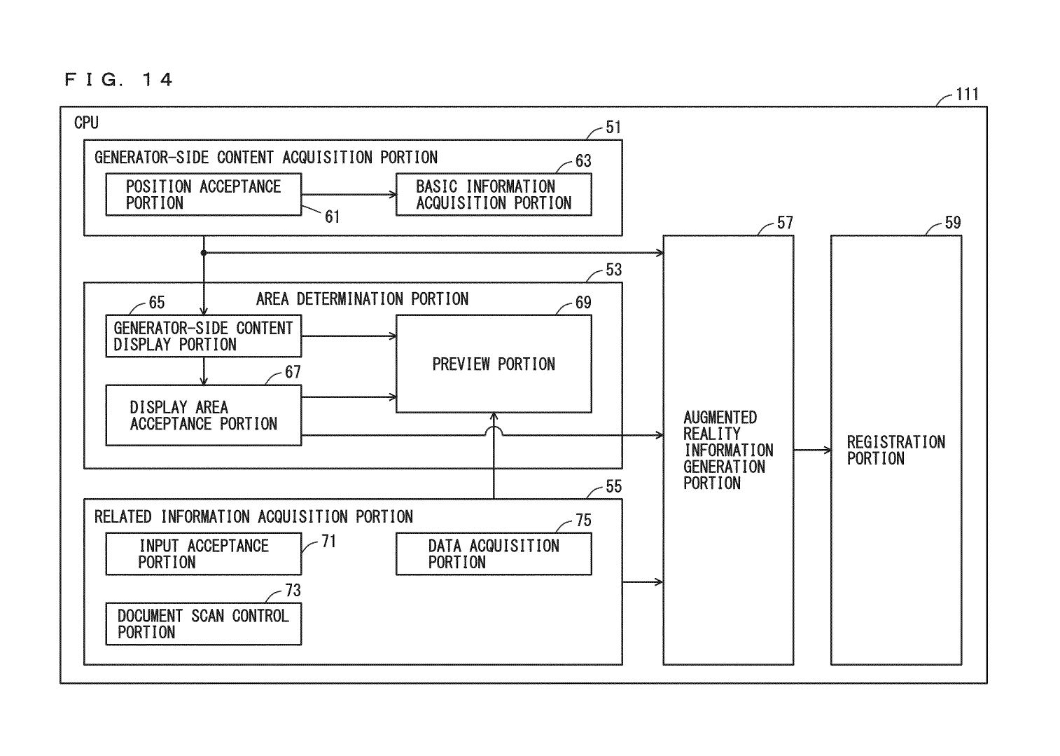

FIG. 12 is a diagram illustrating an example of a format of the basic information. Referring to FIG. 12, the basic information includes a positional information item and a content item, which are part of the augmented reality information.

FIG. 13 is a block diagram showing an example of the functions of CPU 201 of portable information device 200 functioning as the basic information registering apparatus in the first embodiment. The functions shown in FIG. 13 are formed in CPU 201 by CPU 201 of portable information device 200, functioning as the basic information registering apparatus, executing a basic information registration program stored in flash memory 203. The same functions as shown in FIG. 8 are denoted with the same reference signs and an overlapping description will not be repeated.

Referring to FIG. 13, CPU 201 of portable information device 200 functioning as the basic information registering apparatus includes a position acquisition portion 253, an imaging control portion 259, and a basic information registration portion 281. Imaging control portion 259 acquires a captured image output by camera 202 capturing an image of a subject and outputs the acquired captured image to basic information registration portion 281. Position acquisition portion 253 acquires positional information indicating the present position output by position detection unit 209 at the point of time when camera 202 captures an image of a subject, and outputs the acquired positional information to basic information registration portion 281.

Basic information registration portion 281 generates basic information by setting the positional information input from position acquisition portion 253 in the positional information item and setting the captured image input from imaging control portion 259 in the content item, and transmits a basic information registration request including the generated basic information to server 500 through wireless LAN I/F 208.

For example, if a user carries portable information device 200 and captures an image of the whiteboard present in meeting room A as a subject in meeting room A, the basic information including the positional information of meeting room A and the captured image including the whiteboard as a subject are registered in server 500.

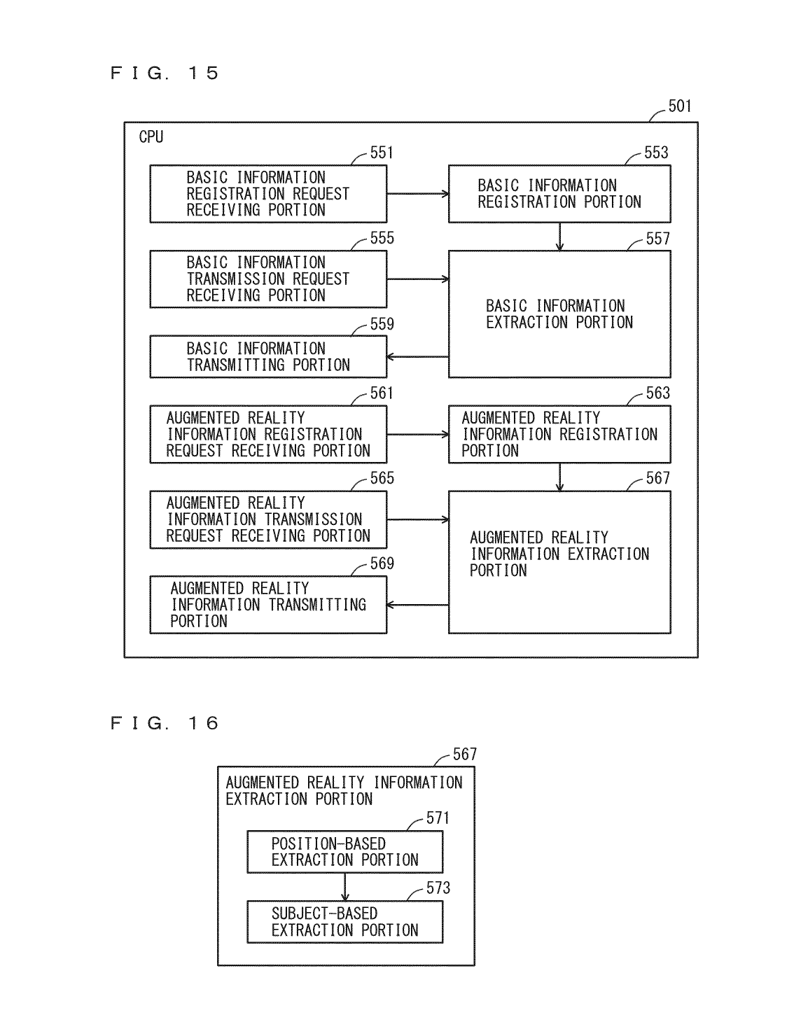

FIG. 14 is a block diagram showing an example of the functions of the CPU of the MFP functioning as the augmented reality information registering apparatus in the first embodiment. The functions shown in FIG. 14 are formed in CPU 111 by CPU 111 of MFP 100, functioning as the augmented reality information registering apparatus, executing an augmented reality information registration program stored in ROM 113, HDD 115, or CD-ROM 118. Referring to FIG. 14, CPU 111 includes a generator-side content acquisition portion 51, an area determination portion 53, a related information acquisition portion 55, an augmented reality information generation portion 57, and a registration portion 59.

Generator-side content acquisition portion 51 includes a position acceptance portion 61 and a basic information acquisition portion 63. Position acceptance portion 61 accepts a geographical position designated by the user. Position acceptance portion 61 displays a two-dimensional map on display unit 161 and accepts a position designated by the user on the displayed map. For example, if the position of meeting room A is designated on the displayed map, the geographical position of meeting room A is accepted. Position acceptance portion 61 outputs positional information indicating the accepted geographical position to basic information acquisition portion 63. The positional information indicating the geographical position of meeting room A is represented by the latitude and longitude of meeting room A.

Basic information acquisition portion 63 acquires the basic information from server 500, in response to input of the positional information from position acceptance portion 61, and outputs the acquired basic information to area determination portion 53 and augmented reality information generation portion 57. Basic information acquisition portion 63 transmits a basic information transmission request including the positional information input from position acceptance portion 61 to server 500 through wireless LAN I/F 208. Server 500 receiving the basic information transmission request, which will be detailed later, returns basic information that includes the positional information indicating the position in a predetermined range from the position specified by the positional information included in the basic information transmission request, among the registered basic information. When acquiring the basic information received by wireless LAN I/F 208 from server 500, basic information acquisition portion 63 outputs the basic information to area determination portion 53. For example, when the user designates the position of meeting room A, the basic information is acquired that includes the positional information indicating the geographical position of meeting room A and includes the background image obtained by capturing an image of the whiteboard as a subject.

Area determination portion 53 includes a generator-side content display portion 65, a display area acceptance portion 67, and a preview portion 69. In response to input of the basic information from basic information acquisition portion 63, generator-side content display portion 65 displays the background image set in the content item in the basic information on display unit 161. Here, the user designates the position of meeting room A in the map, and the background image obtained by capturing an image of the whiteboard as a subject is displayed on display unit 161, by way of example. Generator-side content display portion 65 outputs the background image to display area acceptance portion 67 and preview portion 69.

Display area acceptance portion 67 accepts a display area designated by the user. The display area is an area in the background image. When the user operates operation unit 163 and designates part of the background image displayed on display unit 161, display area acceptance portion 67 accepts the area designated by the user as a display area. The display area may be, for example, a point or an area surrounded by any shape. Here, the display area is a rectangular area. The display area is an area for displaying the related information described later. The related information is information related to a subject included in the background image. The display area is thus an area including a subject included in the background image or an area within a predetermined range from a subject included in the background image. The user may designate part of a subject in the background image, and a rectangular area including the subject may be accepted as a display area. Display area acceptance portion 67 outputs the accepted area to preview portion 69 and augmented reality information generation portion 57. For example, when the display area is a rectangular area in the background image, the display area may be represented by the coordinates of vertexes of two opposite angles of the rectangular area.

Preview portion 69 receives the background image from generator-side content display portion 65, receives the display area from display area acceptance portion 67, and receives related information from related information acquisition portion 55 described below. Preview portion 69 generates a combined image in which an image of the related information is combined in the display area of the background image, and displays the generated combined image on display unit 161. The user looks at the related information superimposed on the background image and then recognizes the position where the related information is displayed in the background image. To change the position where the related information is displayed, the user may operate operation unit 163 and input an instruction to change the display area. Display area acceptance portion 67 thus accepts the changed display area.

Related information acquisition portion 55 acquires related information and outputs the acquired related information to preview portion 69 and augmented reality information generation portion 57. The related information is information defined by the user, such as characters, signs, graphics, photos, or a combination thereof.

Related information acquisition portion 55 includes an input acceptance portion 71, a document scan control portion 73, and a data acquisition portion 75. Input acceptance portion 71 accepts a character or sign input to operation unit 163 by the user as related information. Document scan control portion 73 accepts an image output by document scanning unit 130 scanning a document, as related information. Data acquisition portion 75 accepts data designated by the user as related information from among data stored in HDD 115. Data stored in HDD 115 includes data such as a document or graphics created by another computer, data such as a photo obtained by capturing an image with a digital camera, and data downloaded from a server connected to the Internet. Here, the user allows document scanning unit 130 to scan paper having an image of presentation data to be used in a meeting, as a document, and the image output by document scanning unit 130 is related information, by way of example.

Augmented reality information generation portion 57 receives basic information from basic information acquisition portion 63, receives a display area from display area acceptance portion 67, and receives related information from related information acquisition portion 55. Augmented reality information generation portion 57 generates augmented reality information in which the positional information included in the basic information is set in the positional information item, the background image included in the basic information is set in the content item, the related information input from related information acquisition portion 55 is set in the related information item, and the area information input from display area acceptance portion 67 is set in the area information item. Augmented reality information generation portion 57 transmits an augmented reality information registration request including the generated augmented reality information to server 500 through wireless LAN I/F 208.

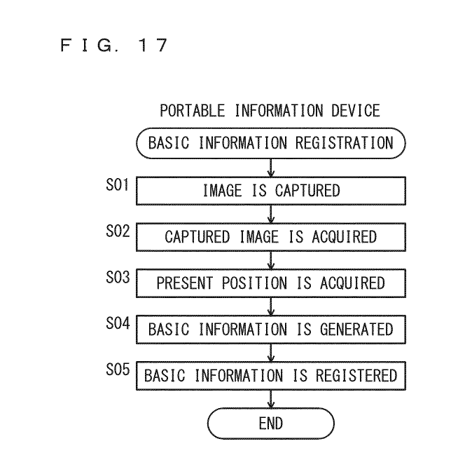

FIG. 15 is a block diagram showing an example of the functions of the CPU of the server in the first embodiment. The functions shown in FIG. 15 are formed in CPU 501 by CPU 501 of server 500 executing an augmented reality information management program stored in ROM 502 or HDD 504. Referring to FIG. 15, CPU 501 includes a basic information registration request receiving portion 551, a basic information registration portion 553, a basic information transmission request receiving portion 555, a basic information extraction portion 557, a basic information transmitting portion 559, an augmented reality information registration request receiving portion 561, an augmented reality information registration portion 563, an augmented reality information transmission request receiving portion 565, an augmented reality information extraction portion 567, and an augmented reality information transmitting portion 569.

In response to communication unit 505 receiving the basic information registration request transmitted by portable information device 200 functioning as the basic information registering apparatus, basic information registration request receiving portion 551 outputs the basic information included in the basic information registration request to basic information registration portion 553. Basic information registration portion 553 registers the basic information by storing the basic information into HDD 504.

In response to communication unit 505 receiving the basic information transmission request transmitted by MFP 100 functioning as the augmented reality information registering apparatus, basic information transmission request receiving portion 555 outputs the positional information included in the basic information transmission request to basic information extraction portion 557. In response to input of the positional information, basic information extraction portion 557 extracts basic information that includes the positional information indicating the position within a predetermined range from the positional information included in the basic information transmission request, from among basic information stored in HDD 504. Basic information extraction portion 557 outputs the extracted basic information to basic information transmitting portion 559. Basic information transmitting portion 559 transmits the basic information extracted by basic information extraction portion 557 to MFP 100 that has transmitted the basic information transmission request, through communication unit 505.

In response to communication unit 505 receiving the augmented reality information registration request transmitted by MFP 100 functioning as the augmented reality information registering apparatus, augmented reality information registration request receiving portion 561 outputs the augmented reality information included in the augmented reality information registration request to augmented reality information registration portion 563. Augmented reality information registration portion 563 registers the augmented reality information by storing the augmented reality information in HDD 504.

In response to communication unit 505 receiving the augmented reality information transmission request transmitted by portable information device 200 functioning as the augmented reality display apparatus, augmented reality information transmission request receiving portion 565 outputs the augmented reality information transmission request to augmented reality information extraction portion 567.

In response to input of the augmented reality information transmission request, augmented reality information extraction portion 567 extracts one of augmented reality information stored in HDD 504, based on the positional information and the captured image included in the augmented reality information transmission request. Augmented reality information transmitting portion 569 transmits the augmented reality information extracted by augmented reality information extraction portion 567 to portable information device 200 that has transmitted the augmented reality information transmission request, through communication unit 505.

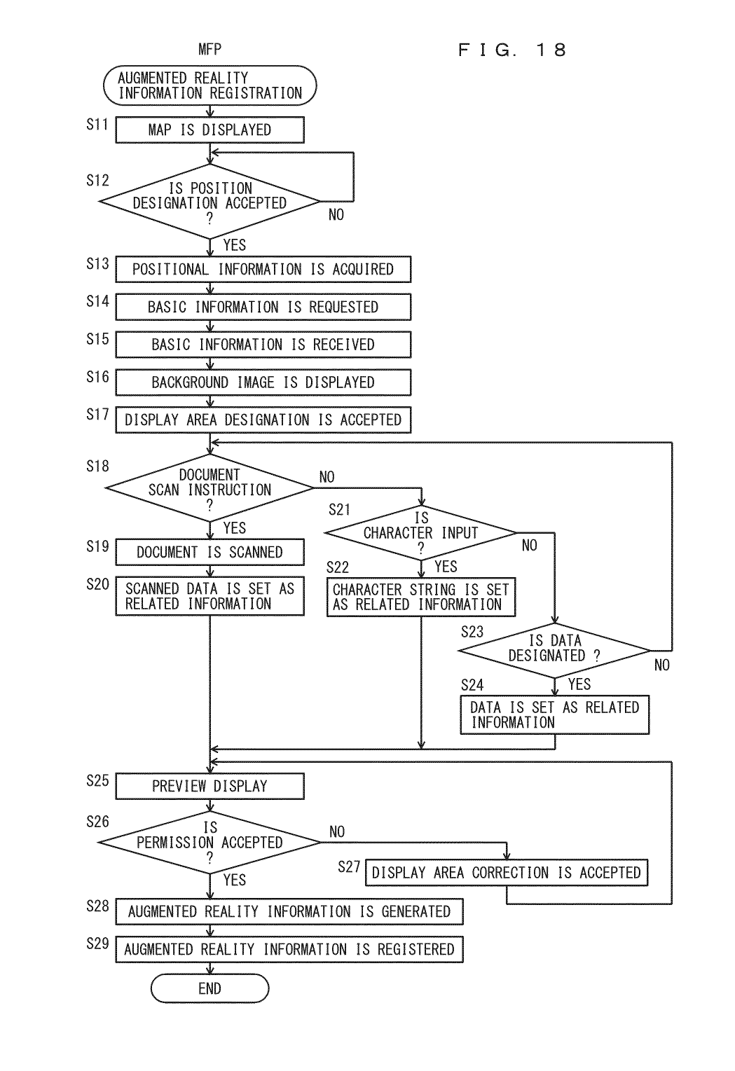

FIG. 16 is a block diagram showing an example of detailed functions of the augmented reality information extraction portion 567 in the first embodiment. Referring to FIG. 16, augmented reality information extraction portion 567 includes a position-based extraction portion 571 and a subject-based extraction portion 573.

Position-based extraction portion 571 extracts augmented reality information that includes the positional information indicating the position present within a predetermined range from the position specified by the positional information included in the augmented reality information transmission request input from augmented reality information transmission request receiving portion 565, and outputs the extracted one or more augmented reality information to subject-based extraction portion 573.

Subject-based extraction portion 573 extracts augmented reality information that includes the background image having the same subject as in the captured image included in the augmented reality information transmission request input from augmented reality information transmission request receiving portion 565, from the one or more augmented reality information input from position-based extraction portion 571. Subject-based extraction portion 573 extracts a characteristic shape from each of the captured image and the background image set in the content item in the augmented reality information, and if the same or similar shape as the characteristic shape of the captured image is included in the characteristic shape in the background image, determines the extracted augmented reality information, as augmented reality information that includes the background image having the same subject as in the captured image. Subject-based extraction portion 573 outputs the extracted augmented reality information to augmented reality information transmitting portion 569.

For example, the outline of a subject included in an image can be extracted by generating a binarized image obtained by binarizing an image or an edge image obtained by differentiating an image. The shape of the extracted outline can be extracted as a characteristic shape. The edge image is an image in which the value of a pixel is set “1” if the density difference between adjacent pixels is equal to greater than a predetermined threshold, and the value of a pixel is set “0” if smaller than the predetermined threshold. For example, when the background image and the captured image include a whiteboard as a subject, each image includes the outline of the whiteboard as a characteristic shape.

It is noted that the augmented reality information transmission request input from augmented reality information transmission request receiving portion 565 does not include positional information, in some cases. In this case, subject-based extraction portion 573 extracts augmented reality information that includes the background image having the same subject as in the captured image included in the augmented reality information transmission request input from augmented reality information transmission request receiving portion 565, from among the augmented reality information stored in HDD 504.

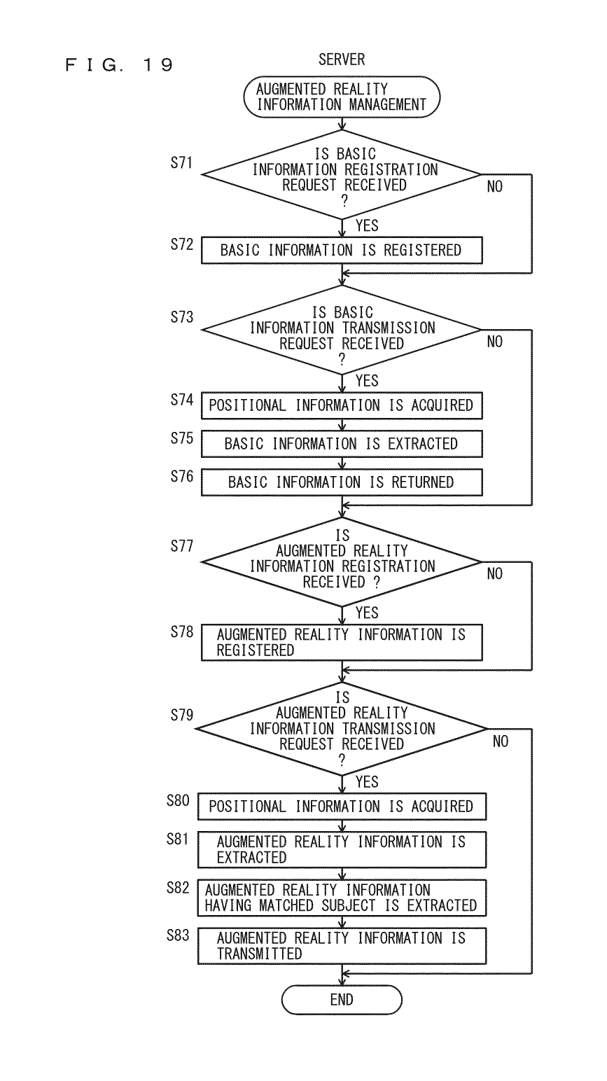

FIG. 17 is a flowchart showing an example of the procedure of a basic information registration process in the first embodiment. The basic information registration process is a process executed by CPU 201 by CPU 201 of portable information device 200, functioning as the basic information registering apparatus, executing a basic information registration program stored in flash memory 203. Referring to FIG. 17, CPU 201 controls camera 202 to capture an image of a subject (step S01). If the user designates the shutter key of operation unit 207, CPU 201 allows camera 202 to capture an image of a subject. In the next step S02, the captured image output by camera 202 is acquired, and the process proceeds to S03. In step S03, positional information is acquired which indicates the present position output by position detection unit 209 at a point of time when camera 202 captures an image of a subject.

Basic information is then generated (step S04). Basic information is generated by setting the captured image acquired in step S02 in the content item and setting the positional information acquired in step S03 in the positional information item.

In the next step S05, the generated basic information is registered in server 500. Specifically, a basic information registration request including the basic information is transmitted to server 500 through wireless LAN I/F 208.

For example, if the user carries portable information device 200 and captures an image of the whiteboard present in meeting room A as a subject in meeting room A, basic information including the captured image including the whiteboard as a subject and the positional information of meeting room A is registered in server 500.

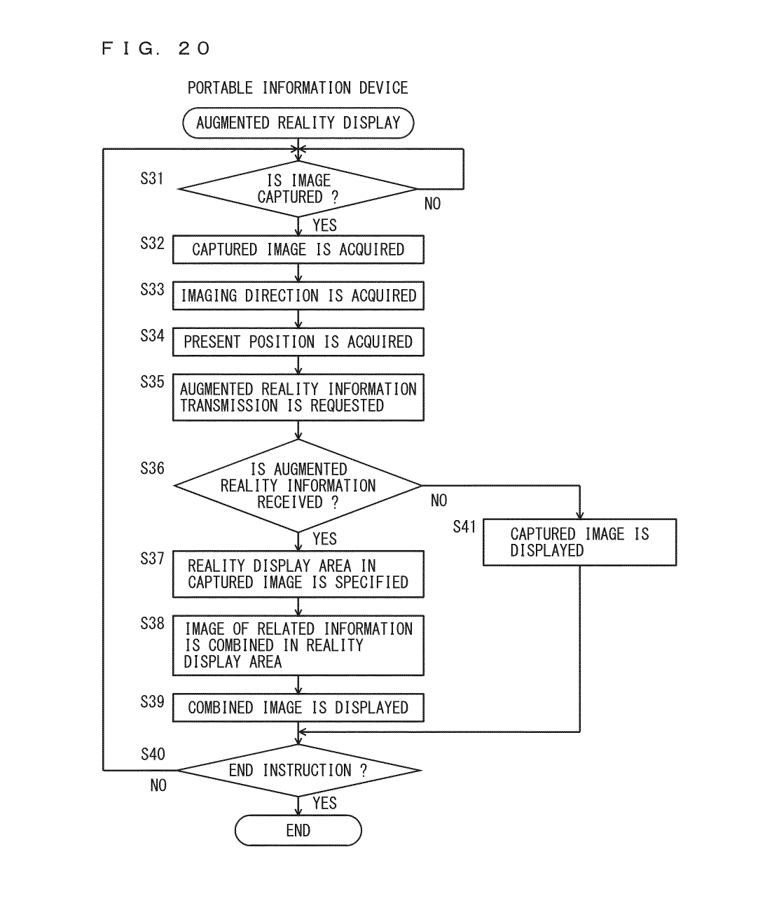

FIG. 18 is a flowchart showing an example of the procedure of an augmented reality information registration process in the first embodiment. The augmented reality information registration process is a process executed by CPU 111 by CPU 111 of MFP 100, functioning as the augmented reality information registering apparatus, executing an augmented reality information registration program stored in ROM 113, HDD 115, or CD-ROM 118. Referring to FIG. 18, CPU 111 displays a two-dimensional map on display unit 161 (step S11). A map downloaded from a computer connected to the Internet is displayed. If a map is stored in advance in HDD 115, the stored map may be displayed.

In the next step S12, designation of a position is accepted. The process waits until a position is accepted (NO in step S12). If a position is accepted (YES in step S12), the process proceeds to step S13. The position designated in the map by the user using operation unit 163 is accepted.

In step S13, the positional information indicating the accepted position is acquired, and the process proceeds to S14. Here, the location of meeting room A is designated in the displayed map, by way of example. In this case, the latitude and longitude of meeting room A is acquired as the positional information indicating the geographical position of meeting room A.

In step S14, the basic information corresponding to the positional information acquired in step S13 is acquired. Specifically, a basic information transmission request including the positional information is transmitted to server 500 through communication I/F unit 112. Server 500, receiving the basic information transmission request, returns basic information that includes the positional information indicating the position within a predetermined range from the position specified by the positional information included in the basic information transmission request, from among basic information registered in server 500. In the next step S15, the basic information received by wireless LAN I/F 208 from server 500 is acquired. For example, basic information is acquired that is registered in server 500 by portable information device 200 functioning as the basic information registering apparatus, includes the positional information indicating the geographical position of meeting room A, and includes the background image including the whiteboard captured as a subject.

In step S16, the background image set in the content item in the basic information is displayed on display unit 161. The background image including the whiteboard captured as a subject is thus displayed on display unit 161. A display area designated by the user is then accepted (step S17). The display area is an area in the background image. If the user operates operation unit 163 and designates part of the background image displayed on display unit 161, the area designated by the user is accepted as a display area. The display area may be a point or may be an area surrounded by any shape. Here, the display area is a rectangular area. The user may designate part of a subject in the background image, and a rectangular area including the subject may be accepted as a display area.

In step S18, it is determined whether a document scan instruction is accepted. If operation unit 163 detects a document scan instruction input by the user, the document scan instruction is accepted. If a document scan instruction is accepted, the process proceeds to S19. If not, the process proceeds to S21. In step S19, document scanning unit 130 scans a document. An image obtained by scanning a document is then set as related information (step S20), and the process proceeds to S25.

In step S21, it is determined whether a character is input. If operation unit 163 detects a character input by the user, it is determined that a character is input. If a character is input, the process proceeds to S22. If not, the process proceeds to S23. In step S22, the character string detected by operation unit 163 is set as related information, and the process proceeds to S25.

In step S23, it is determined whether designation of data is accepted. If operation unit 163 detects an operation of designating data input by the user, designation of data is accepted. If designation of data is accepted, the process proceeds to S24. If not, the process returns to step S19. In step S24, the data designated by the user from among data stored in HDD 115 is set as related information, and the process proceeds to S25. Data stored in HDD 115 includes data such as a document or graphics created by another computer, data such as a photo obtained by capturing an image with a digital camera, and data downloaded from a server connected to the Internet. Here, the user allows document scanning unit 130 to scan paper having an image of presentation data to be used in a meeting, as a document, and the image output by document scanning unit 130 is related information, by way of example.

In step S25, the related information is previewed. Specifically, the image of the related information set in any one of step S20, step S22, and step S24 is displayed in the display area accepted in step S17 in the background image displayed on display unit 161 in step S16. In step S26, it is determined whether permission from the user is accepted. If permission is accepted (YES in step S26), the process proceeds to S28. If not (NO in step S26), the process proceeds to S27. In step S27, a correction on the display area is accepted, and the process returns to step S25. If the process proceeds from step S27 to step S25, in step S25, the image of the related information is displayed in the display area corrected in step S27.

In step S28, augmented reality information is generated, and the process proceeds to S29. Augmented reality information is generated by setting the positional information and the background image included in the basic information acquired in step S14 in the positional information item and the content item, respectively, setting the related information set in one of step S20, step S22 and step S24 in the related information item, and setting the display area accepted in step S17 in the area information item.

In the next step S29, the generated augmented reality information is registered in server 500. The process then ends. Specifically, an augmented reality information registration request including the augmented reality information is transmitted to server 500 through wireless LAN I/F 208.

FIG. 19 is a flowchart showing an example of the procedure of an augmented reality information management process in the first embodiment. The augmented reality information management process is a process executed by CPU 501 by CPU 501 of server 500 executing an augmented reality information management program stored in ROM 502 or HDD 504. Referring to FIG. 19, CPU 501 determines whether a basic information registration request has been received (step S71). If communication unit 505 has received a basic information registration request from portable information device 200 functioning as the basic information registering apparatus, the process proceeds to S72. If not, the process proceeds to S73. In step S72, the basic information is registered by storing the basic information included in the received basic information registration request into HDD 504. The process proceeds to S73.

In step S73, it is determined whether a basic information transmission request has been received. If communication unit 505 has received a basic information transmission request from MFP 100 functioning as the augmented reality information generating apparatus, the process proceeds to S74. If not, the process proceeds to S77. In step S74, the positional information included in the received basic information transmission request is acquired. Basic information that includes the positional information indicating the position within a predetermined range from the position defined by the acquired positional information is then extracted from among basic information stored in HDD 504 (step S75). In step S76, the extracted basic information is transmitted to MFP 100 that has transmitted the basic information transmission request, through communication unit 505. The process then proceeds to S77.

In step S77, it is determined whether an augmented reality information registration request has been received. If communication unit 505 has received an augmented reality information registration request from MFP 100 functioning as the augmented reality information generating apparatus, the process proceeds to S78. If not, the process proceeds to S79. In step S78, the augmented reality information is registered by storing the augmented reality information included in the received augmented reality information registration request into HDD 504, and the process proceeds to S79.

In step S79, it is determined whether an augmented reality information transmission request has been received. If communication unit 505 has received an augmented reality information transmission request from portable information device 200 functioning as the augmented reality display apparatus, the process proceeds to S80. If not, the process ends. In step S80, the positional information included in the received augmented reality information transmission request is acquired. Augmented reality information that includes the positional information indicating the position within a predetermined range from the position defined by the acquired positional information is then extracted from among the augmented reality information stored in HDD 504 (step S81).

In the next step S82, augmented reality information that includes the background image having the same subject as the subject in the captured image included in the received augmented reality information transmission request received in step S79 is extracted from the augmented reality information extracted in step S81. A characteristic shape is extracted from each of the captured image and the background image, and if the same or similar shape as the characteristic shape in the captured image is included in the characteristic shape of the background image, it is determined that the captured image and the augmented reality information have the same subject. For example, the outline of a subject included in an image can be extracted by generating a binarized image obtained by binarizing an image or an edge image obtained by differentiating an image. The shape of the extracted outline can be extracted as a characteristic shape.

In the next step S83, the extracted augmented reality information is transmitted to portable information device 200 that has transmitted the augmented reality information transmission request, through communication unit 505. The process then ends.

FIG. 20 is a flowchart showing an example of the procedure of an augmented reality display process in the first embodiment. The augmented reality display process in the first embodiment is a process executed by CPU 201 by CPU 201 of portable information device 200 executing an augmented reality display program stored in flash memory 203. Referring to FIG. 20, CPU 201 controls camera 202 to capture an image of a subject (step S31). If the user designates the shutter key of operation unit 207, CPU 201 allows camera 202 to capture an image of a subject. The process waits until an image of a subject is captured (NO in step S31). If an image of a subject is captured (YES in step S31), the process proceeds to S32. In step S32, the captured image output by camera 202 is acquired, and the process proceeds to S33. In step S33, the imaging direction is acquired. Azimuth detection unit 210 is controlled so that azimuth detection unit 210 detects the imaging direction of camera 202. In the next step S34, position detection unit 209 is controlled so that the positional information indicating the present position output by position detection unit 209 at a point of time when camera 202 captures an image of a subject is acquired.

An augmented reality information transmission request is then transmitted (step S35). An augmented reality information transmission request including the captured image acquired in step S32 and the positional information acquired in step S34 is transmitted to server 500 through wireless LAN I/F 208.

In the next step S36, it is determined whether the augmented reality information returned from server 500 has been received. If the augmented reality information has been received (YES in step S36), the process proceeds to S37. If not, the process proceeds to S41. In step S41, the captured image acquired in step S32 is displayed on display unit 206, and the process proceeds to S40.

The augmented reality information transmission request may include the imaging direction of camera 202 in addition to the positional information, and server 500 may extract augmented reality information in which the positional information indicating the position within a range defined by the present position and the acquired azimuth is defined. Azimuth detection unit 210 is controlled such that azimuth detection unit 210 detects the imaging direction of camera 202, and the azimuth output by azimuth detection unit 210 at a point of time when camera 202 captures an image is acquired. If a plurality of augmented reality information are acquired in step S35, the imaging direction of camera 202 of portable information device 200 may be changed after a plurality of augmented reality information are acquired, so that augmented reality information in which the positional information indicating the position within a range defined by the present position and the acquired azimuth is defined is extracted from among the plurality of augmented reality information acquired in step S35.

In step S37, a reality display area in the captured image is specified. Specifically, based on the area information set in the area information item in the augmented reality information, the relative position to the subject in the background image set in the content item in the augmented reality information is specified, and the area present at the specified relative position is determined as the reality display area, with respect to the subject in the captured image.

In the next step S38, a combined image is generated, in which an image of the related information is combined in the reality display area specified in the captured image. In the next step S39, the generated combined image is displayed on display unit 161, and the process proceeds to S40.

In step S40, it is determined whether an instruction to terminate the augmented reality display process has been accepted. If an instruction to terminate has been accepted, the process ends. If not, the process returns to step S31.

If a plurality of augmented reality information are received in step S36, in step S39, a combined image in which images of the respective related information of the plurality of augmented reality information are combined is displayed, and when the user selects one of the images of the plurality of related information, a combined image in which only the image of the selected related information is combined may be displayed.

### Modification to First Embodiment

In the foregoing first embodiment, portable information device 200 has been described as an example of the augmented reality display apparatus. However, HMD 400 may function as the augmented reality display apparatus. In this case, CPU 401 of HMD 400 have the same functions as the functions of CPU 201 of portable information device 200 shown in FIG. 8, except that display control portion 257 is different.

Display control portion 257 in CPU 401 of HMD 400 does not display the captured image on display unit 206 in response to input of the captured image from imaging control portion 259 but displays the related information in the related information item included in the augmented reality information on display unit 404, based on the augmented reality information input from augmented reality information receiving portion 263. The user wearing HMD 400 actually sees the same image as the captured image through the display surface of display unit 404. Therefore, the area corresponding to the reality display area determined in the captured image by reality display area determination portion 258 is specified in the display surface of display unit 404, and an image of the related information is displayed in the area specified in the display surface of display unit 404.

Here, if the user wearing HMD 400 looks at the whiteboard in meeting room A, the whiteboard will be a subject of camera 402. In this case, augmented reality information is received from server 500, in which the positional information indicating the position of meeting room A is set in the positional information item, the background image including the whiteboard captured as a subject is set in the content item, an image of a meeting material is set as related information, and the area including the entire drawing surface of the whiteboard in the background image is set in the area information item. When the image of the meeting material as related information appears on display unit 404, the user sees the image of the meeting material displayed on the display surface of the display unit 404, on the drawing surface of the whiteboard that the user sees through the display surface of display unit 404.

In the modification, although CPU 401 of HMD 400 executes the augmented reality display process shown in FIG. 20, step S38, step S39 and step S41 are different. CPU 401 of HMD 400 specifies an area in the display surface of display unit 404 that corresponds to the reality display area in the captured image specified in step S37, without generating a combined image in step S38. In the next step S39, an image of related information is displayed in the specified area in the display surface of display unit 404, and the process proceeds to S40. In step S41, nothing appears, and the process proceeds to S40.

As described above, server 500 included in augmented reality display system 1 in the first embodiment stores augmented reality information including a background image (first content), area information indicating a display area defined by the relative position to a subject (object) in the background image, and related information related to the subject. When receiving a captured image (second content) from portable information device 200 (augmented reality display apparatus), server 500 extracts augmented reality information that includes a background image having the same subject as the subject in the captured image from among the stored augmented reality information, and transmits the extracted augmented reality information to portable information device 200. At portable information device 200, related information can be displayed at a position where the relative position to the subject (whiteboard) in the captured image is identical with the relative position between the subject (whiteboard) in the background image and the display area (the drawing surface of the whiteboard). The related information thus can be displayed at the position defined by the augmented reality information, in the captured image obtained in portable information device 200.

MFP 100 functioning as the augmented reality information generating apparatus determines the display area (the drawing surface of the whiteboard) defined by the relative position to the subject (whiteboard) in the background image (content) acquired by an external device (PC 300), acquires the related information related to the subject, and generates augmented reality information in which the background image, the area information indicating the display area, and the related information are associated with each other. The relative position between the related information and the subject thus can be associated with the subject in the background image. Portable information device 200 functioning as the augmented reality display apparatus acquires a captured image (first content), acquires augmented reality information that includes the background image (second content) having the same subject as the subject (object) in the captured image from server 500, determines a reality display area in which the relative position to the subject (whiteboard) in the captured image has the same relation with the relative position between the subject in the background image and the display area, and displays the related information included in the augmented reality information in the reality display area (the drawing surface of the whiteboard). The related information thus can be displayed in the captured image obtained by portable information device 200, at a position defined by the augmented reality information generated by MFP 100 functioning as the augmented reality information generating apparatus.

MFP 100 functioning as the augmented reality generating apparatus displays a content and superimposes related information in the display area specified by the area information in the content. The user thus can recognize the position where the related information is displayed relative to the object included in the content.

Since MFP 100 functioning as the augmented reality generating apparatus accepts designation of the display area in the content, the user can designate any position in the content.

Since MFP 100 functioning as the augmented reality generating apparatus acquires image data obtained by optically scanning a document with document scanning unit 130 and converting the scanned document into electronic data, as related information, an image obtained by scanning a document can be set as related information.

Since MFP 100 functioning as the augmented reality generating apparatus acquires data designated by the user from among data stored in HDD 115 or an external device, as related information, data designated by the user can be set as related information.

Portable information device 200 functioning as the augmented reality display apparatus acquires a captured image (first content), acquires augmented reality information that includes the background image (second content) having the same object as the subject (object) in the captured image from server 500, determines a reality display area in which the relative position to the subject in the captured image has the same relation with the relative position between the object in the background image and the display area, and displays the related information in the reality display area. Accordingly, the related information associated with the subject in the captured image by the augmented reality information that includes the background image having the same subject as in the captured image is displayed at the same relative position as the relative position defined for the subject in the background image. The information related to the subject in the captured image thus can be displayed at a predetermined position for the subject.

Portable information device 200 functioning as the augmented reality display apparatus acquires an image output by camera 202 capturing an image of a subject as a captured image (first content) and acquires augmented reality information that includes a background image having a subject matched with the captured image. The information related to the subject in the captured image thus can be displayed at a relative position defined for the subject.

If the augmented reality information further includes positional information indicating the geographical position of the subject in the background image (second content), portable information device 200 functioning as the augmented reality display apparatus acquires the geographical position at a point of time when camera 202 captures an image of a subject, and acquires one or more augmented reality information that includes the positional information indicating the position present within a predetermined range from the acquired position, from server 500. This processing facilitates acquisition of augmented reality information.

### Second Embodiment

In the first embodiment, server 500 extracts augmented reality information that is matched with the position of portable information device 200 functioning as the augmented reality display apparatus and the captured image obtained by portable information device 200, from among the augmented reality information stored in server 500. In augmented reality display system 1 in the second embodiment, this processing is partially performed by portable information device 200. The difference from augmented reality display system 1 in the first embodiment will be mainly described below.

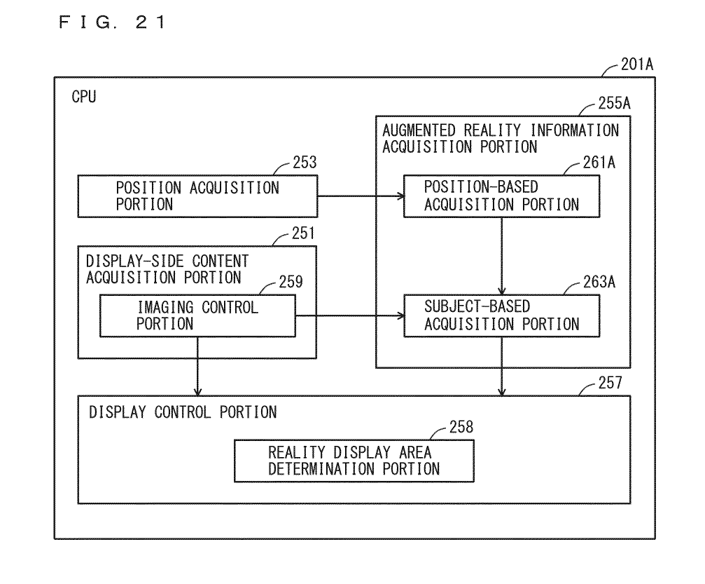

FIG. 21 is a block diagram showing an example of the overall functions of the CPU of portable information device 200 functioning as the augmented reality display apparatus in the second embodiment. Referring to FIG. 21, the functions are different from those in FIG. 8 in that augmented reality information acquisition portion 255 is changed to an augmented reality information acquisition portion 255A. The other functions are the same as those in FIG. 8 and a description thereof is not repeated here.

Augmented reality information acquisition portion 255A acquires augmented reality information from server 500. Augmented reality information acquisition portion 255A includes a position-based acquisition portion 261A and a subject-based acquisition portion 263A. Position-based acquisition portion 261A transmits an augmented reality information transmission request including the positional information input from position acquisition portion 253 to server 500 through wireless LAN I/F 208. The IP address of server 500 may be stored in advance in flash memory 203 of portable information device 200. Server 500 receiving the augmented reality information transmission request, which will be detailed later, extracts augmented reality information that includes the positional information indicating the position present within a predetermine range from the position specified by the positional information included in the augmented reality information transmission request, and returns the extracted one or more augmented reality information. When wireless LAN I/F 208 receives one or more augmented reality information from server 500, augmented reality information acquisition portion 255A outputs the one or more augmented reality information to subject-based acquisition portion 263A.

Subject-based acquisition portion 263A receives a captured image from imaging control portion 259 and receives one or more augmented reality information from position-based acquisition portion 261A. Subject-based acquisition portion 263A extracts augmented reality information that includes a background image having the same subject as in the captured image input from imaging control portion 259, from among the one or more augmented reality information input from position-based acquisition portion 261A. Subject-based acquisition portion 263A extracts a characteristic shape from each of the captured image and the background image set in the content item in the augmented reality information, and, if the same or similar shape as the characteristic shape in the captured image is included in the characteristic shape in the background image, determines the extracted augmented reality information, as augmented reality information that includes a background image having the same subject as in the captured image. Subject-based acquisition portion 263A outputs the augmented reality information including a background image having the same subject as in the captured image input from imaging control portion 259, to display control portion 257.

For example, the outline of a subject included in an image can be extracted by generating a binarized image obtained by binarizing an image or an edge image obtained by differentiating an image. The shape of the extracted outline can be extracted as a characteristic shape. The edge image is an image in which the value of a pixel is set “1” if the density difference between adjacent pixels is equal to greater than a predetermined threshold, and the value of a pixel is set “0” if smaller than the predetermined threshold. For example, when the background image and the captured image include a whiteboard as a subject, each image includes the outline of the whiteboard as a characteristic shape.

If position detection unit 209 fails to measure the present position, position acquisition portion 253 cannot acquire positional information. In this case, position-based acquisition portion 261A receives all of the augmented reality information stored in server 500 from server 500 and outputs the received augmented reality information to subject-based acquisition portion 263A.

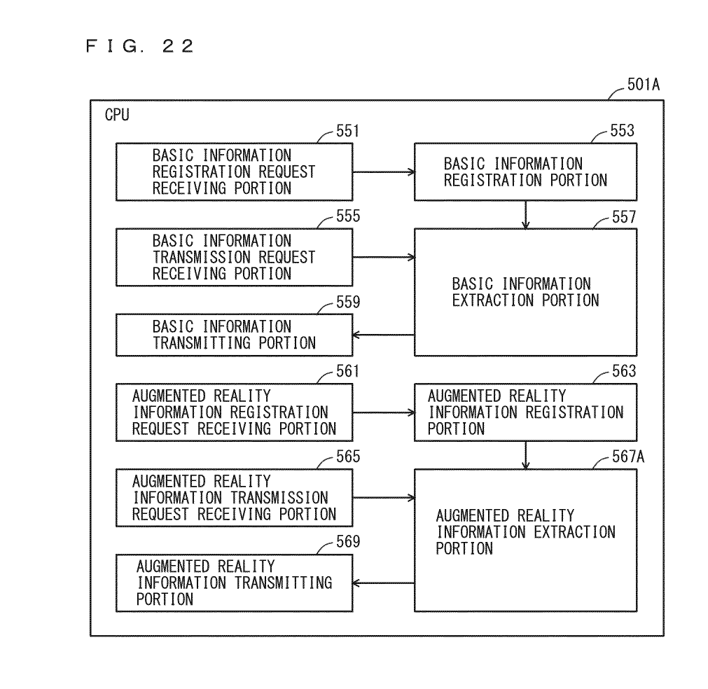

FIG. 22 is a block diagram showing an example of the functions of the CPU of the server in the second embodiment. Referring to FIG. 22, the functions are different from those in FIG. 15 in that augmented reality information extraction portion 567 is changed to an augmented reality information extraction portion 567A. The other functions are the same as the functions shown in FIG. 15 and a description thereof is not repeated here.

The augmented reality information transmission request received by augmented reality information transmission request receiving portion 565 from portable information device 200 functioning as the augmented reality display apparatus includes positional information. In response to input of the augmented reality information transmission request, augmented reality information extraction portion 567A extracts augmented reality information that includes positional information indicating the position within a predetermined range from the positional information included in the augmented reality information transmission request, from among the augmented reality information stored in HDD 504. Augmented reality information extraction portion 567 outputs the extracted augmented reality information to augmented reality information transmitting portion 569.

Augmented reality information transmitting portion 569 transmits the augmented reality information extracted by augmented reality information extraction portion 567, to portable information device 200 that has transmitted the augmented reality information transmission request, through communication unit 505.

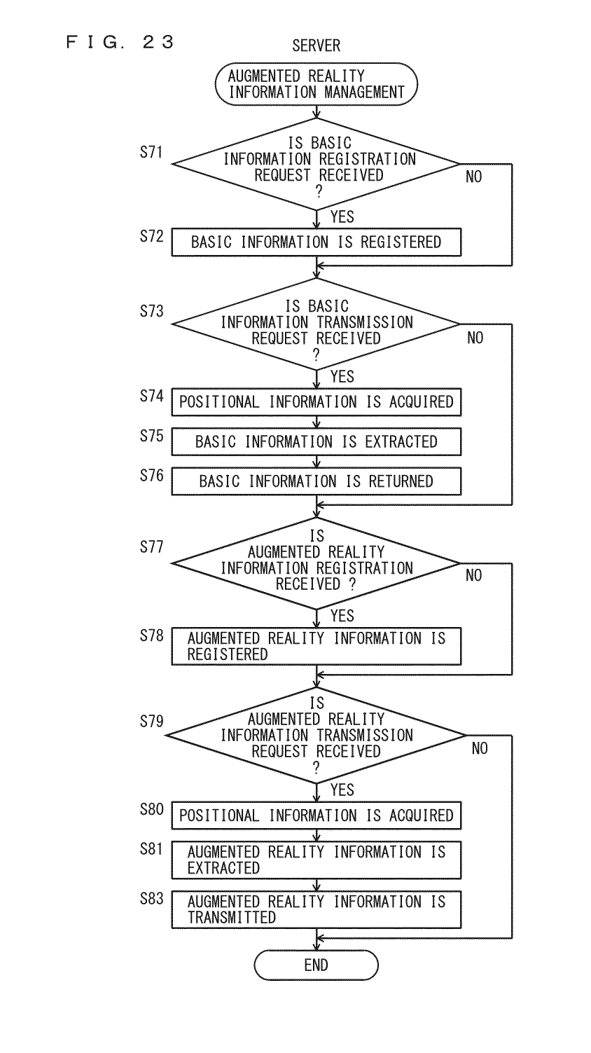

FIG. 23 is a flowchart showing an example of the procedure of an augmented reality information management process in the second embodiment. Referring to FIG. 23, the augmented reality information management process differs from that shown in FIG. 19 in the first embodiment in that step S82 is deleted. The other processing is the same as in the augmented reality information management process in the first embodiment shown in FIG. 19 and a description thereof is not repeated here.

Since step S82 is deleted, in step S83, all of the augmented reality information extracted in step S81 are transmitted to portable information device 200 that has transmitted the augmented reality information transmission request, through communication unit 505. The process then ends. In step S81, augmented reality information that includes positional information indicating the position within a predetermined range from the position defined by the positional information included in the augmented reality information transmission request is extracted from among the augmented reality information stored in HDD 504. In other words, all of the augmented reality information that includes the positional information indicating the position within a predetermined range from the present position of portable information device 200 functioning as the augmented reality display apparatus are transmitted to portable information device 200.

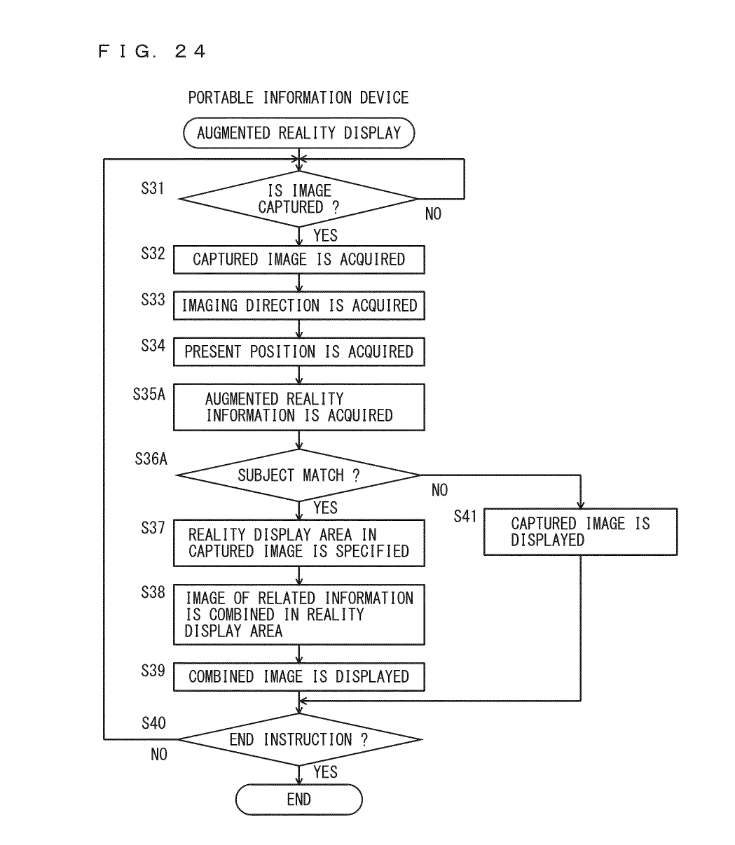

FIG. 24 is a flowchart showing an example of the procedure of an augmented reality display process in the second embodiment. Referring to FIG. 24, the augmented reality display process differs from that shown in FIG. 20 in that step S35 and step S36 are changed to step S35A and step S36A. The other processing is the same as in the augmented reality display process shown in FIG. 20 and a description thereof is not repeated here. In step S35A, augmented reality information is acquired. An augmented reality information transmission request including the positional information acquired in step S34 is transmitted to server 500 through wireless LAN I/F 208, and the augmented reality information returned from server 500 is acquired.

The augmented reality information transmission request may include the imaging direction of camera 202 in addition to the positional information indicating the present position, and server 500 may extract the augmented reality information in which the positional information indicating the position within a range defined by the present position and the acquired azimuth is defined. Azimuth detection unit 210 is controlled such that azimuth detection unit 210 detects the imaging direction of camera 202, and the azimuth output by azimuth detection unit 210 at a point of time when camera 202 captures an image is acquired. If a plurality of augmented reality information are acquired in step S35A, the imaging direction of camera 202 of portable information device 200 may be changed after a plurality of augmented reality information are acquired, so that the augmented reality information in which positional information indicating the position within a range defined by the present position and the acquired azimuth is defined is extracted from among the plurality of augmented reality information acquired in step S35A.

In the next step S36A, it is determined whether the subject of the captured image captured in step S31 and acquired in step S32 agrees with the subject of the background image included in the augmented reality information. A characteristic shape is extracted from each of the captured image and the background image, and, if the same or similar shape as the characteristic shape in the captured image is included in the characteristic shape in the background image, determines that the captured image and the augmented reality information have the same subject. For example, the outline of a subject included in an image can be extracted by generating a binarized image obtained by binarizing an image or an edge image obtained by differentiating an image. The shape of the extracted outline can be extracted as a characteristic shape.

In step S36A, if it is determined that the subjects are the same, the process proceeds to step S37. If not, the process proceeds to S41.

### Modification to Second Embodiment

In the foregoing second embodiment, portable information device 200 has been described as an example of the augmented reality display apparatus. However, HMD 400 may function as the augmented reality display apparatus. In this case, CPU 401 of HMD 400 have the same functions as the functions of CPU 201 of portable information device 200 shown in FIG. 21, except that display control portion 257 is different.

Display control portion 257 of CPU 401 of HMD 400 does not display the captured image on display unit 206 in response to input of the captured image from imaging control portion 259, but displays the related information set in the related information item included in the augmented reality information on display unit 404, based on the augmented reality information input from augmented reality information receiving portion 263. The user wearing HMD 400 actually sees the same image as the captured image through display unit 404. Therefore, an area in the captured image that corresponds to the area specified by the area information set in the area information item in the background image set in the content item included in the augmented reality information is specified in display unit 404, and the image of the related information is displayed in the specified area in display unit 404.

Here, if the user wearing HMD 400 looks at the whiteboard in meeting room A, the whiteboard will be a subject of camera 402. In this case, augmented reality information is received from server 500, in which the positional information indicating the position of meeting room A is set in the positional information item, the background image having the whiteboard captured as a subject is set in the content item, an image of a meeting material is set as related information, and the area including the entire drawing surface of the whiteboard in the background image is set in the area information item. Then, when the image of the meeting material is displayed as related information on display unit 404, the user sees the image of the meeting material displayed on display unit 404, in the drawing surface of the whiteboard that the user sees through display unit 404.

In the modification, although CPU 401 of HMD 400 executes the augmented reality display process shown in FIG. 24, step S38, step S39 and step S41 are different. CPU 401 of HMD 400 specifies an area in the display surface of display unit 404 that corresponds to the reality display area in the captured image specified in step S37, without generating a combined image, in step S38. In the next step S39, the image of the related information is displayed in the specified area in the display surface of display unit 404, and the process proceeds to S40. In step S41, nothing appears, and the process proceeds to S40.

Augmented reality display system 1 in the second embodiment achieves the same effects as in augmented reality display system 1 in the first embodiment.

### Third Embodiment

In the first and second embodiments, a background image is set in the content item in the augmented reality information. In the third embodiment, data stored in a computer is set in the content item in the augmented reality information.

An augmented reality display system 1B in the third embodiment will be described, focusing on the difference from augmented reality display system 1 in the first embodiment.

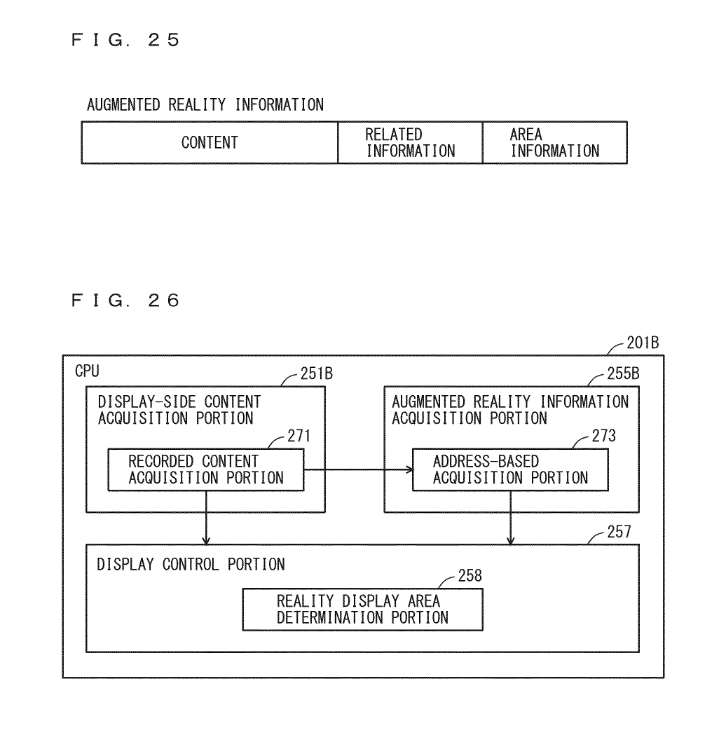

FIG. 25 is a diagram showing an example of a format of augmented reality information in the third embodiment. Referring to FIG. 25, the augmented reality information in the third embodiment includes a content item, a related information item, and an area information item. A content is set in the content item. The content is data stored in a computer and here data stored in PC 300, by way of example. Information related to an image of the content specified by content identification information set in the content item is set in the related information item. Area information indicating the position of an area of a portion related to the related information in the image of the content specified by the content identification information set in the content item is set in the area information item.

FIG. 26 is a block diagram showing an example of the overall functions of CPU 201 of portable information device 200 functioning as the augmented reality display apparatus in the third embodiment. Referring to FIG. 26, the functions are different from those shown in FIG. 8 in that position acquisition portion 253 is deleted and that display-side content acquisition portion 251 and augmented reality information acquisition portion 255 are changed to a display-side content acquisition portion 251A and an augmented reality information acquisition portion 255A, respectively. The other functions are the same as the functions shown in FIG. 8 and a description thereof is not repeated here.

Display-side content acquisition portion 251B includes a recorded content acquisition portion 271. Recorded content acquisition portion 271 acquires data stored in another computer as a content (first content), outputs content identification information for identifying the acquired content to augmented reality information acquisition portion 255B, and outputs the content to display control portion 257. Recorded content acquisition portion 271 is, for example, a task that executes a browsing program that downloads and displays a Web page stored in a Web server and written in a markup language. It is also a task that executes a file search program that enables viewing of data stored in another computer connected through network 2. The content is not limited to a Web page written in a markup language and includes data linked by the Web page, for example, an image or moving images.

Display control portion 257 controls display unit 206 to allow display unit 206 to display an image of the content input from recorded content acquisition portion 271.

Augmented reality information acquisition portion 255B acquires augmented reality information from server 500. Augmented reality information acquisition portion 255B includes an address-based acquisition portion 273. In response to input of the content identification information of a content from recorded content acquisition portion 271, address-based acquisition portion 273 transmits an augmented reality information transmission request including the input content identification information to server 500 through wireless LAN I/F 208. The IP address of server 500 may be stored in advance in flash memory 203 of portable information device 200.

Server 500 receiving the augmented reality information transmission request, which will be detailed later, returns the augmented reality information that includes the content specified by the content identification information included in the augmented reality information transmission request. In other words, server 500 returns the augmented reality information that includes the same content as the content acquired by recorded content acquisition portion 271. The content acquired by recorded content acquisition portion 271 and the content included in the augmented reality information acquired by augmented reality information acquisition portion 255B are the same and therefore include the same object. When wireless LAN I/F 208 receives the augmented reality information from server 500, address-based acquisition portion 273 outputs the augmented reality information to display control portion 257.

When display-side content acquisition portion 251 acquires a content of moving images, display control portion 257 replays the moving images. Augmented reality information acquisition portion 255B transmits an augmented reality information transmission request including the content identification information that specifies one frame specified by display control portion 257 in the moving images, whereby at a point of time when a still image of the frame is displayed by display control portion 257, the augmented reality information including the still image is acquired from server 500.

In response to input of a content from recorded content acquisition portion 271, display control portion 257 displays an image of the content on display unit 206. When augmented reality information is input from address-based acquisition portion 273, display control portion 257 displays the related information set in the related information item included in the augmented reality information on display unit 206. The content input from recorded content acquisition portion 271 is hereinafter referred to as a first content, and the content set in the content item in the augmented reality information input from address-based acquisition portion 273 is referred to as a second content. The first content and the second content have the same content identification information and therefore are the same content.

Display control portion 257 includes a reality display area determination portion 258. Reality display area determination portion 258 specifies the relative position to an object in the second content set in the content item in the augmented reality information, based on the area information set in the area information item in the augmented reality information, and determines an area present at the specified relative position as a reality display area, with respect to the object in the first content.

Display control portion 257 displays the related information set in the related information item in the augmented reality information, in the reality display area determined in the captured image. Specifically, display control portion 257 generates a combined image in which the image of the related information is combined in the reality display area in the captured image, and displays the generated combined image on display unit 206.

Here, a background image having a whiteboard captured as a subject is stored in PC 300, the background image stored in PC 300 is the second content, and augmented reality information is received from server 500, in which the second content is set in the content item, the image as a meeting material is set as related information, and the area including the entire drawing surface of the whiteboard in the background image is set in the area information item, by way of example. In this case, if the user of portable information device 200 downloads the second content stored in PC 300, a combined image is displayed on display unit 206, in which the image of the meeting material as related information is combined in the drawing surface of the whiteboard in the image of the second content. In actuality, even when a character or other data is not written on the drawing surface of the whiteboard included in the second content stored in PC 300, a combined image is displayed on display unit 206 of portable information device 200, in which the image of the meeting material is combined in the area of the drawing surface of the whiteboard in the image of the second content.

An example of a method of registering augmented reality information in server 500 will now be illustrated. Here, the augmented reality information generating apparatus generates augmented reality information, based on the data (second content) stored in PC 300, and registers the generated augmented reality information in server 500, by way of example. It is assumed that the augmented reality information generating apparatus is MFP 100.

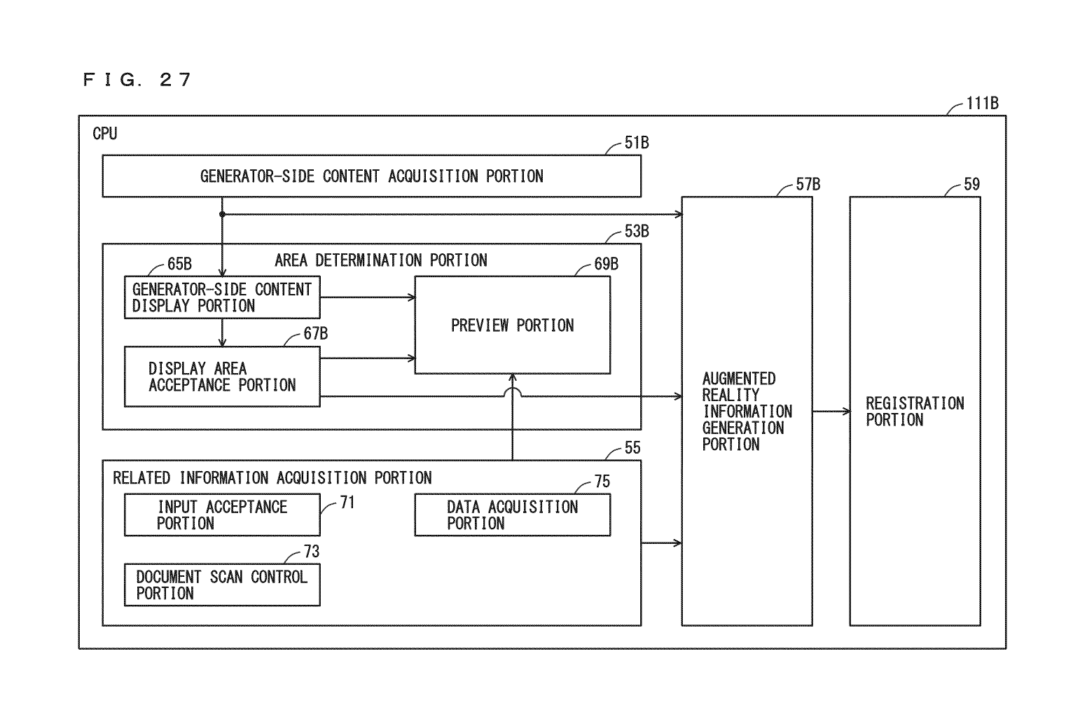

FIG. 27 is a block diagram showing an example of the functions of the CPU of the MFP functioning as the augmented reality information registering apparatus in the third embodiment. The functions shown in FIG. 27 are different from the functions of CPU 111 of MFP 100 functioning as the augmented reality information registering apparatus in the first embodiment shown in FIG. 14 in that generator-side content acquisition portion 51, area determination portion 53, and augmented reality information generation portion 57 are changed to a generator-side content acquisition portion 51B, an area determination portion 53B, and an augmented reality information generation portion 57B, respectively. The other functions are the same as the functions shown in FIG. 14 and a description thereof is not repeated here.

Generator-side content acquisition portion 51B acquires data stored in another computer as a content (second content) and outputs the acquired content to area determination portion 53B and augmented reality information generation portion 57B. Generator-side content acquisition portion 51B is, for example, a task that executes a browsing program or a task that executes a file search program.

Area determination portion 53B includes a generator-side content display portion 65B, a display area acceptance portion 67B, and a preview portion 69B. In response to input of a content from generator-side content acquisition portion 51B, generator-side content display portion 65B displays an image of the content on display unit 161. For example, when the user browses data stored in PC 300, the image of data is displayed on display unit 161. Generator-side content display portion 65B outputs the image of the content to display area acceptance portion 67B and preview portion 69B.

Display area acceptance portion 67B accepts a display area designated by the user. The display area is an area in the image of the content. If the user operates operation unit 163 and designates part of the image of the content displayed on display unit 161, display area acceptance portion 67B accepts the area designated by the user as a display area. The display area is an area surrounded by any shape. Here, the display area is a rectangular area. The display area is an area for displaying the related information described later. Display area acceptance portion 67B outputs the accepted display area to preview portion 69 and augmented reality information generation portion 57B. For example, if the display area is a rectangular area in the image of the content, the display area may be represented by the coordinates of vertexes of two opposite angles of the rectangular area.

Preview portion 69B receives the image of the content from generator-side content display portion 65B, receives the display area from display area acceptance portion 67B, and receives the related information from related information acquisition portion 55. Preview portion 69B generates a combined image in which the image of the related information is combined in the display area of the image of the content, and displays the generated combined image on display unit 161. The user looks at the related information superimposed on the image of the content and then recognizes the position where the related information is displayed in the image of the content. To change the position where the related information is displayed, the user may operate operation unit 163 and input an instruction to change the display area. Display area acceptance portion 67B thus accepts the changed display area.

Related information acquisition portion 55 acquires the related information and outputs the acquired related information to preview portion 69B and augmented reality information generation portion 57B. The related information is information defined by a user and is characters, signs, graphics, photos, or a combination thereof.

Augmented reality information generation portion 57B receives the content from generator-side content acquisition portion 51B, receives the display area from display area acceptance portion 67B, and receives the related information from related information acquisition portion 55. Augmented reality information generation portion 57B generates augmented reality information in which the content input from generator-side content acquisition portion 51B is set in the content item, the related information input from related information acquisition portion 55 is set in the related information item, and the area information input from display area acceptance portion 67B is set in the area information item. Augmented reality information generation portion 57B transmits an augmented reality information registration request including the generated augmented reality information to server 500 through wireless LAN I/F 208.

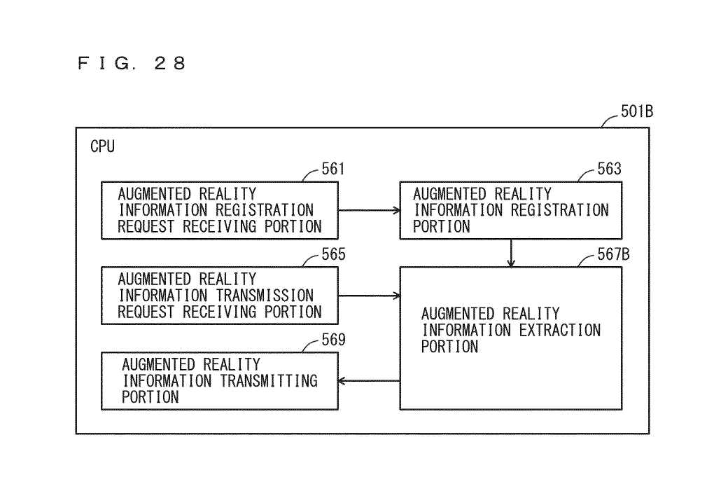

FIG. 28 is a block diagram showing an example of the functions of the CPU of the server in the third embodiment. Referring to FIG. 28, the functions are different from those of CPU 501 of server 500 in the first embodiment shown in FIG. 15 in that basic information registration request receiving portion 551, basic information registration portion 553, basic information transmission request receiving portion 555, basic information extraction portion 557, and basic information transmitting portion 559 are deleted and that augmented reality information extraction portion 567 is changed to an augmented reality information extraction portion 567B. The other functions are the same as the functions shown in FIG. 15 and a description thereof is not repeated here.

In response to input of an augmented reality information transmission request, augmented reality information extraction portion 567B extracts augmented reality information from among the augmented reality information stored in HDD 504, based on the content identification information included in the augmented reality information transmission request, and outputs the extracted augmented reality information to augmented reality information transmitting portion 569. Specifically, augmented reality information in which the content having the same content identification information as the content identification information included in the augmented reality information transmission request is set in the content item is extracted among the augmented reality information stored in HDD 504.

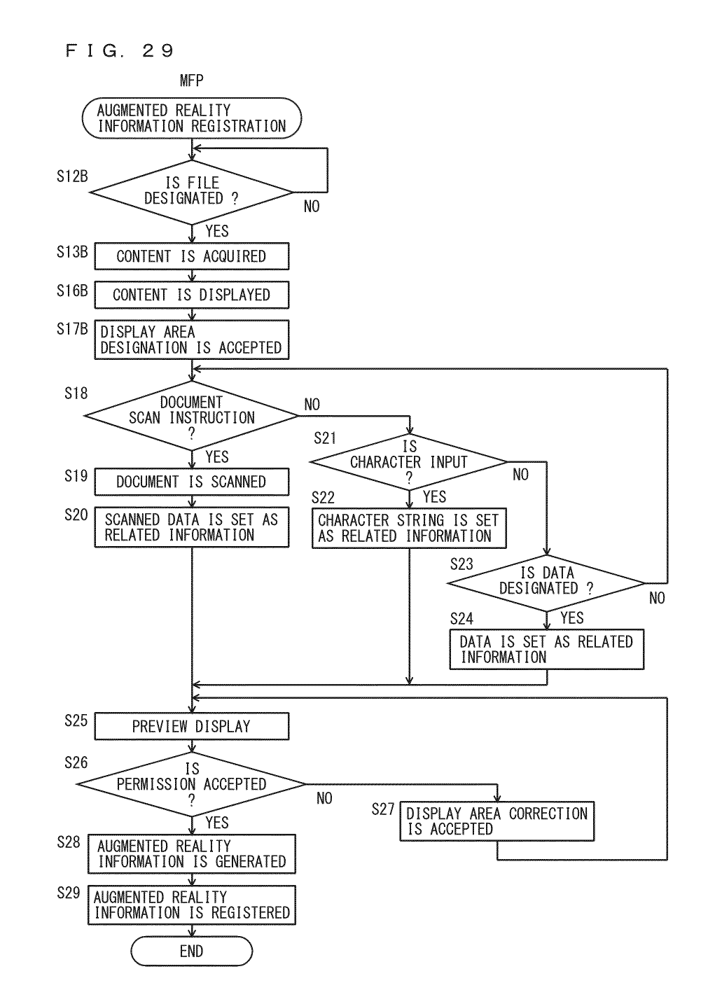

FIG. 29 is a flowchart showing an example of the procedure of an augmented reality information registration process in the third embodiment. Referring to FIG. 29, the augmented reality information registration process differs from that shown in FIG. 18 in the first embodiment in that step S11, step S14, and step S15 are deleted, and that step S12, step S13, step S16, step S17, and step S28 are changed to step S12B, step S13B, step S16B, step S17B, and step S28B. The other processing is the same as the processing shown in FIG. 18 and a description thereof is not repeated here.

CPU 111 determines whether designation of a file has been accepted. Designation of a file is accepted if the user inputs an operation of designating a file to operation unit 163. For example, when the task that executes a browsing program accepts an operation of designating the URL of a Web page, designation of the file of the Web page specified by that URL is accepted. Alternatively, when the task that executes a file search program accepts an operation of designating data stored in HDD 115 or another computer, designation of the file of the designated data is accepted. The process waits until designation of a file is accepted (NO in step S12B). If designation of a file has been accepted (YES in step S12B), the process proceeds to step S13B.

In step S13B, data of the designated file is acquired, and the process proceeds to step S16B. Here, data stored in PC 300 is designated, by way of example. In this case, data stored in PC 300 is downloaded from PC 300.

In step S16B, an image of the data acquired in step S13B is displayed on display unit 161. The image of the data stored in PC 300 is thus displayed on display unit 161.

A display area designated by the user is accepted (step S17B). The display area is an area in the image of the content. If the user operates operation unit 163 and designates part of the image of the content displayed on display unit 161, the area designated by the user is accepted as a display area. The display area may be a point or may be an area surrounded by any shape. Here, the display area is a rectangular area.

In step S28B, augmented reality information is generated, and the process proceeds to S29. Augmented reality information is generated by setting the content acquired in step S13B in the content item, setting the related information set in one of step S20, step S22 and step S24 in the related information item, and setting the display area accepted in step S17B in the area information item.

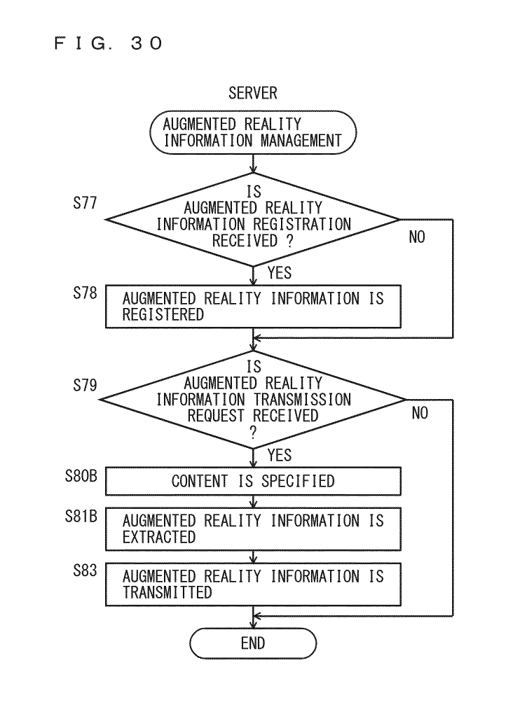

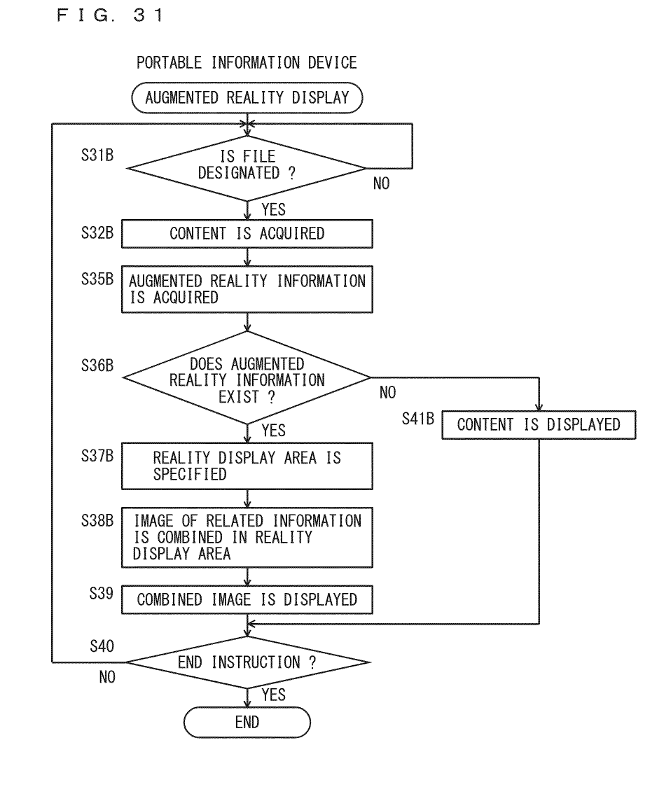

FIG. 30 is a flowchart showing an example of the procedure of an augmented reality information management process in the third embodiment. Referring to FIG. 30, CPU 501 determines whether an augmented reality information registration request has been received, in step S77. If communication unit 505 has received an augmented reality information registration request from MFP 100 functioning as the augmented reality information generating apparatus, the process proceeds to S78. If not, the process proceeds to S79. In step S78, augmented reality information is registered by storing the augmented reality information included in the received augmented reality information registration request into HDD 504. The process then proceeds to S79.

In step S79, it is determined whether an augmented reality information transmission request has been received. If communication unit 505 has received an augmented reality information transmission request from portable information device 200 functioning as the augmented reality display apparatus, the process proceeds to step S80B. If not, the process ends. In step S80B, the content identification information included in the received augmented reality information transmission request is acquired and the content is then specified. The augmented reality information in which the acquired content identification information is set in the content item is then extracted from among the augmented reality information stored in HDD 504 (step S81B).

In the next step S83, the extracted augmented reality information is transmitted to portable information device 200 that has transmitted the augmented reality information transmission request, through communication unit 505. The process then ends. In other words, the augmented reality information that includes the content identification information of the data of the same file as the file acquired by portable information device 200 functioning as the augmented reality display apparatus is transmitted to portable information device 200.

FIG. 31 is a flowchart showing an example of the procedure of an augmented reality information display process in the third embodiment. The augmented reality display process in the third embodiment is a process executed by CPU 201 by CPU 201 of portable information device 200 executing an augmented reality display program stored in flash memory 203. Referring to FIG. 31, CPU 201 determines whether designation of a file has been accepted (step S31B). Designation of a file is accepted if the user inputs an operation of designating a file to operation unit 207. For example, when the task that executes a browsing program accepts an operation of designating the URL of a Web page, designation of the file of the Web page specified by that URL is accepted. Alternatively, when the task that executes a file search program accepts an operation of designating data stored in flash memory 203 or another computer, designation of the file of the designated data is accepted. The process waits until designation of a file is accepted (NO in step S31B). If designation of a file has been accepted (YES in step S31B), the process proceeds to step S32B.

In step S32B, data of the designated file is acquired, and the process proceeds step S35B. Here, data stored in PC 300 is designated, by way of example. In this case, data stored in PC 300 is downloaded from PC 300.

In step S35B, augmented reality information is acquired. An augmented reality information transmission request including the content identification information of the content acquired in step S32B is transmitted to server 500 through wireless LAN I/F 208, and the augmented reality information returned from server 500 is acquired.

In the next step S36B, it is determined whether the augmented reality information returned from server 500 has been received. If the augmented reality information has been received (YES step S36B), the process proceeds to step S37B. If not, the process proceeds to step S41B. In step S41B, the image of the content acquired in step S32B is displayed on display unit 206, and the process proceeds to S40.

In step S37B, a reality display area in the captured image is specified. Specifically, the relative position to the subject in the content set in the content item in the augmented reality information is specified based on the area information set in the area information item in the augmented reality information, and an area present at the specified relative position is determined as a reality display area, with respect to the subject in the content acquired in step S32B. In the next step S38B, a combined image is generated, in which the image of the related information is combined in the specified reality display area in the image of the content. In the next step S39, the generated combined image is displayed on display unit 161, and the process proceeds to S40.

In step S40, it is determined whether an instruction to terminate the augmented reality display process has been accepted. If an instruction to terminate has been accepted, the process ends. If not, the process returns to step S31.

As described above, in augmented reality display system 1B in the third embodiment, MFP 100 functioning as the augmented reality information generating apparatus acquires a content (for example, Web page or image) stored in PC 300, determines a display area defined by the relative position to an object in the acquired content, acquires the related information related to the object, and generates augmented reality information in which the content, the area information indicating the display area, and the related information are associated with each other. The related information and the relative position to the object thus can be associated with the object in the content.

Portable information device 200 functioning as the augmented reality display apparatus acquires a content stored in PC 300 as the first content from PC 300 and acquires augmented reality information that includes the second content having the same identification information as the identification information of the acquired first content. Portable information device 200 thus displays the information related to the object in the first content stored in PC 300, at the relative position defined for the object. The information related to the object in the content stored in PC 300 thus can be displayed at a predetermined position for the object.

Although the present invention has been described and illustrated in detail, it is clearly understood that the same is by way of illustration and example only and is not to be taken by way of limitation, the spirit and scope of the present invention being limited only by the terms of the appended claims.

### APPENDIX

(1) The augmented reality display apparatus according to any one of claims 8 to 10, further comprising a display portion to display an image, wherein the display control portion includes a combined image generation portion to generate a combined image in which the related information included in the augmented reality information is superimposed on the first content, and displays the generated combined image on the display portion.

According to this aspect, a combined image in which the related information is superimposed on the first content is generated, and the combined image is displayed. Therefore, the related information can be associated with an object in the first content.

(2) The augmented reality display apparatus according to claim 9, further comprising a transparent display portion arranged at a position defined with respect to an optical axis of the imaging portion, wherein the reality display area determination portion determines a reality display area in a display surface of the display portion, based on a captured image output by the imaging portion, and the display control portion displays the related information included in the augmented reality information in the reality display area in the display surface of the display portion.

According to this aspect, a reality display area is determined in the display surface of the display portion, based on the captured image output by the imaging portion, and the related information is displayed in the reality display area in the display surface of the display portion. Therefore, the related information can be displayed to be associated with the subject viewed by the user through the display portion.

What is claimed is:

1. An augmented reality display system comprising an augmented reality information generating apparatus and an augmented reality display apparatus,
the augmented reality information generating apparatus comprising a processor configured to:
acquire a content stored in an external device from the external device;
determine a display area defined by a relative position to an object in the content;
acquire related information related to the object; and
generate augmented reality information in which the content, area information indicating the display area, and the related information are associated with each other,
the augmented reality display apparatus comprising a processor configured to:
acquire a first content;
acquire augmented reality information that includes a second content having an identical object with an object in the acquired first content;
determine a reality display area in which a relative position to the object in the first content has an identical relation with a relative position between the object in the second content and the display area; and
display the related information included in the acquired augmented reality information, in the determined reality display area.

2. An augmented reality information generating apparatus comprising a processor configured to:
acquire a content stored in an external device from the external device;
determine a display area defined by a relative position to an object in the acquired content;
acquire related information related to the object; and
generate augmented reality information in which the content, area information indicating the display area, and the related information are associated with each other.

3. The augmented reality information generating apparatus according to claim 2, wherein said processor is further configured to
display the acquired content, and
superimpose the acquired related information in the display area specified by the area information in the displayed content.

4. The augmented reality information generating apparatus according to claim 3, wherein said processor is further configured to accept designation of the display area in the displayed content.

5. The augmented reality information generating apparatus according to claim 2, further comprising a document scanner to output image data obtained by converting an optically scanned document into electronic data, wherein said processor is further configured to acquire, as the related information, the image data output by the document scanner.

6. The augmented reality information generating apparatus according to claim 2, further comprising a data storage to store data, wherein said processor is further configured to acquire, as the related information, data designated by a user from among the data stored in the data storage.

7. An augmented reality display apparatus comprising a processor configured to:
acquire a first content;
acquire augmented reality information that includes a second content having an identical object with an object in the acquired first content,
the augmented reality information including, in addition to the second content, area information indicating a display area defined by a relative position to an object in the second content, and related information related to the object;
determine a reality display area in which a relative position to the object in the first content has an identical relation with a relative position between the object in the second content and the display area; and
display the related information included in the augmented reality information in the determined reality display area.

8. The augmented reality display apparatus according to claim 7, further comprising an image capturing unit to capture an image of a subject, wherein
said processor is further configured to acquire, as the first content, an image output by the image capturing unit capturing an image of a subject, and
acquire augmented reality information that includes the second content having a subject matched with the acquired first content.

9. The augmented reality display apparatus according to claim 8, wherein
the augmented reality information further includes positional information indicating a geographical position of a subject in the second content, and
said processor is further configured to
acquire a geographical position at a point of time when the image capturing portion captures an image of a subject, and
acquire one or more augmented reality information that includes positional information indicating a position within a predetermined range from the acquired position.

10. The augmented reality display apparatus according to claim 7, wherein
said processor is further configured to acquire, as the first content, a content stored in an external device from the external device, and
acquire augmented reality information that includes a second content having identical identification information with identification information of the acquired first content.

11. A server comprising:
an augmented reality information storage to store augmented reality information including a first content, area information indicating a display area defined by a relative position to an object in the first content, and related information related to the object; and
a processor configured to
receive a second content from an augmented reality display apparatus,
extract augmented reality information that includes a first content having an identical object with an object in the received second content, from among the stored augmented reality information, and
transmit the extracted augmented reality information to the augmented reality display apparatus.

12. A non-transitory computer-readable recording medium encoded with an augmented reality information generating program, the program causing a computer controlling an augmented reality generating apparatus to execute:
a generator-side content acquisition step of acquiring a content stored in an external device from the external device;
an area determination step of determining a display area defined by a relative position to an object in the acquired content;
a related information acquisition step of acquiring related information related to the object; and
an augmented reality information generation step of generating augmented reality information in which the content, area information indicating the display area, and the related information are associated with each other.

13. A non-transitory computer-readable recording medium encoded with an augmented reality display program, the program causing a computer controlling an augmented reality display apparatus to execute:
a display-side content acquisition step of acquiring a first content;
an augmented reality information acquisition step of acquiring augmented reality information that includes a second content having an identical object with an object in the acquired first content,
the augmented reality information including, in addition to the second content, area information indicating a display area defined by a relative position to an object in the second content, and related information related to the object;
a reality display area determination step of determining a reality display area in which a relative position to the object in the first content has an identical relation with a relative position between the object in the second content and the display area; and
a display control step of displaying the related information included in the augmented reality information in the determined reality display area.
